(19) United States
(12) Patent Application Publication
(10) Pub. No.: US 2008/0220169 A1
(43) Pub. Date: Sep. 11, 2008

(54) Parylene-C Stencils

(75) Inventors: Ali Khademhosseini, Cambridge, MA (US); Bimalraj Rajalingam, Allston, MA (US)

Correspondence Address: FISH & RICHARDSON PC, P.O. BOX 1022, MINNEAPOLIS, MN, 55440-1022, US

(73) Assignee: The Brigham and Women's Hospital, Inc., Boston, MA (US)

(21) Appl. No.: 11/975,019

(22) Filed: Oct. 16, 2007

Related U.S. Application Data
(60) Provisional application No. 60/852,329, filed on Oct. 16, 2006.

(51) Int. Cl. B05D 1/32; B32B 33/00

(52) U.S. Cl. 427/282; 428/41.8

(57) ABSTRACT

A reuseable microfabrication stencil is described that can be reversibly sealed on various substrates to pattern biomolecules and biomaterials such as proteins and cells. The stencil may be used for the generation of both static and dynamic co-cultures, and cell aggregates. A multilayer stencil is described that can be used in biological patterning and used to create static and dynamic co-cultures and cell aggregates. Processes for producing and using the microfabrication stencils are also described.

### CROSS-REFERENCE TO RELATED APPLICATIONS

The present application claims the benefit of the filing date of U.S. Provisional Application No. 60/852,329, which was filed on Oct. 16, 2006. The disclosure of the prior application is considered part of (and is incorporated by reference in) the disclosure of this application.

### STATEMENT AS TO FEDERALLY SPONSORED RESEARCH

Funding for the work described herein was provided in part by the National Institutes of Health, grant nos. HL60435 and DE 16516. The federal government may have certain rights in the invention.

### TECHNICAL FIELD

This invention relates to micro- and nano-scale technology, and more particularly to biocompatible micro- and nano-scale fabrication.

### BACKGROUND

Every year billions of dollars are spent in research and development activities in the biological sciences. Microscale and nanoscale technologies are potential tools for miniaturizing assays and enabling high-throughput experiments. These technologies include MicroElectroMechanical Systems (MEMS) and NanoElectroMechanical Systems (NEMS), which are extensions of the semiconductor and microelectronics industries and can be used to control features at length scales<1 μm to 1 cm. Some of these technologies are biocompatible and may be integrated with biomaterials to facilitate the fabrication of cell-material composites and used for tissue engineering.

In the body, cells are exposed to a complex in vivo cellular microenvironment. Many cell decision processes are influenced by the cellular microenvironment, including adjacent cells, soluble factors, matrix components, and spatially oriented signals that are dissolved in the microenvironment, attached to neighboring cells, or present on the surfaces of biological structures. For example, biological processes such as stem cell differentiation, wound healing, and cell development involve dynamic interactions between cells and their microenvironment.

The ability to engineer the complexity of the cellular microenvironment, or control these dynamic processes in vitro, may be useful in the development of tissue engineered constructs and improved cell culture systems, including studying biological processes and directing stem cell differentiation. For example, stem cells differentiate based on a series of spatially and temporally regulated signals from the extracellular microenvironment. To study these environmental cues, it may be beneficial to engineer systems in which the interaction of stem cells with other cells is temporally and spatially controlled. However, conventional cell culture methods generally lack the ability to control these complex signals.

Microfabrication, a type of MEMS and NEMS, has been increasingly implemented in biomedical and biological applications. Patterning methods such as microcontact printing, ink jet printing, electron beam patterning, and dry and photo lithography have been used to pattern cells and biomolecules. However, limitations associated with these techniques including high equipment costs and the extensive expertise required to conduct the procedures generally limit the applicability and use of such methods. Moreover, the harsh environment of these methods generally denatures cells and biomolecules used.

### SUMMARY

A reusable, reversibly sealing, microfabricated stencil may be used on various surfaces to enable surface patterning. After patterning, the stencil can be removed from the surface, cleaned, and reused. The stencil used is biocompatible, reusable, structurally sound, and versatile enough to be used for various micro- and nanopatterning applications. Processes for producing the stencil are also described. These stencils can be used to generate micropatterns (as small as 1 μm or less) of proteins, cells, and other biomolecules. The stencil may also be used for the generation of static co-cultures, dynamic co-cultures, and cell aggregates, including fibroblasts, hepatocytes, and stem cells.

The use of a stencil enables micropatterning techniques and methods that are inexpensive, easy to perform, and widely applicable, as described herein, can serve an important role in spreading and increasing the use of micropatterning in biological and biomedical applications. The patterned deposition of cells and biomolecules on surfaces is a potentially useful tool for in vitro diagnostics, high-throughput screening and tissue engineering. In particular, simple, inexpensive methods can be important for wide usage of micro- and nano-patterning techniques for biological and biomedical applications.

Parylene-C stencil technology may be used for dynamic co-patterning of proteins as well as for co-patterning of cells of various types, and combinations thereof. The parylene-C technology allows for precise control of the cellular microenvironment, combining cell patterning technology with a flexible way to generate a series of temporally controlled co-cultures. Dynamic co-culturing using parylene-C stencils may find application in various applications including studies investigating cellular interactions in controlled microenvironments such as studies of ES cell differentiation, wound healing, and development.

As used herein, the term “micro” generally encompasses both micro and nano. For example, as used herein, the term microscale includes the term nanoscale, the term microfabrication includes the term nanofabrication, and the term micropatterning includes the term nanopatterning.

As used herein, the following abbreviations represent the following:
HA hyaluronic acid
PDMS poly(dimethylsiloxane)
Parylene di-para-xylylene
Parylene-C di-chloro-di-para-xylylene
PBS phosphate buffered saline
FN fibronectin

A process for using a stencil in a microfabrication process is described. The process includes applying a biocompatible, prefabricated, microfabrication stencil to a substrate to form a complex, applying a biomaterial over the complex, removing the stencil from a substrate, and cleaning the stencil to remove biological deposits. The process may also include reusing the stencil in a microfabrication process, or applying a second biomaterial over the substrate after removal of the stencil. The stencil may be formed from a polymeric material, from a hydrophobic material, from a material having a Young's Modulus of 1.0 GPa or greater, from parylene, or from parylene-C. The biomaterial may include a protein or a cell. The stencil may be cleaned using plasma cleaning or trypsin. Applying a biomaterial may include incubating a biomaterial.

A process of forming complex cell-cell interactions, including applying a parylene microfabrication stencil to a substrate to form a complex, incubating a first type of cell over the complex, altering the complex to produce an altered structure, and incubating a second type of cell over the altered structure is also described. Altering the complex may include removing the stencil, washing the complex to remove cells from the stencil, or incubating a cell adhesion promoter over the complex. The method may also include altering the characteristics of the stencil, which can include changing the stencil surface property from cell-repelling to cell-attracting. The adhesion promoter may be applied to the substrate prior to applying the stencil to the substrate. The method may further include altering the altered structure to produce a second altered structure, or incubating a third cell type over the second altered structure. The parylene microfabrication stencil may be prefabricated.

A process of protein microfabrication, including applying a parylene microfabrication stencil to a substrate to form a complex, incubating a protein over the complex, removing the stencil from the complex, and cleaning the stencil is also described. The process may further include incubating a second protein over the substrate after removal of the stencil.

A process of forming complex cell-cell interactions, including applying a prefabricated parylene microfabrication stencil to a substrate to form a complex, incubating a first type of cell over the complex, incubating a second type of cell over the complex, removing the stencil from the complex, incubating a third type of cell over the substrate, and cleaning the stencil is also described.

A process of forming a complex cellular microenvironment, including applying a parylene microfabrication stencil to a substrate to form a complex, incubating a first type of cell over the complex, removing the stencil from the complex, incubating a second type of cell or a protein over the substrate, and cleaning the stencil is also described.

A process of forming a complex cellular microenvironment, including applying a parylene microfabrication stencil to a substrate to form a complex, incubating a first type of cell over the complex, altering the surface adhesiveness of the stencil, incubating a second type of cell over the complex, removing the stencil from the complex, incubating a protein over the substrate, incubating a third type of cell over the substrate, and cleaning the stencil is also described. The process may include altering the surface adhesiveness of the parylene microfabrication stencil prior to application of the stencil to the substrate.

A process of preparing a reusable microfabrication stencil is also described. The process includes preparing a wafer substrate, depositing a parylene material on the wafer, applying a pattern over the parylene material, selectively removing parylene material to incorporate the pattern into the parylene material to form a stencil, and removing the stencil from the wafer. The process may further include applying a protective layer onto the parylene. The process may further include applying a photoresist layer over the protective layer. The protective layer may include a metal. The parylene material may be removed using ICP-RIE. The parylene material may be parylene-C. Depositing a parylene material may include a vapor deposition process.

A process of preparing a reusable microfabrication stencil is described that includes preparing a wafer substrate, depositing a parylene material on the wafer to form a parylene material layer having a thickness of at least 5 μm, applying a pattern over the parylene material, and selectively removing parylene material to incorporate the pattern into the parylene material to form a stencil. The parylene material layer may have a thickness of at least 7 μm, and may include parylene-C.

Also described is an article including a substrate and a parylene microfabrication stencil reversibly bonded to the substrate, wherein the microfabrication stencil includes one or more features, and wherein the microfabrication stencil may be removed from the substrate and reversibly bonded to a second substrate without significant damage to the stencil or to features of the stencil. The microfabrication stencil may include parylene-C.

Another article includes a substrate and a parylene microfabrication stencil reversibly bonded to the substrate, wherein the microfabrication stencil has a thickness of at least 5 μm. The microfabrication stencil may include one or more features.

A reusable parylene microfabrication stencil is described that includes one or more features and has a thickness of at least 5 μm. The stencil may be reversibly bonded to a substrate. The stencil may have sufficient strength to be used and reused at least five times without significant damage to the features of the stencil or to the stencil material.

A process for preparing a reusable microfabrication stencil may include creating one or more features in a parylene material layer to form the stencil, wherein the stencil has sufficient strength to be used and reused at least five times without significant damage to the features of the stencil or to the stencil material.

A process for preparing a reusable microfabrication stencil is described that includes creating one or more features in a parylene material layer to form the stencil, wherein the stencil has a thickness of at least 5 μm.

A process for preparing a reusable microfabrication stencil may include depositing a parylene material on a wafer substrate to form a parylene material layer and creating one or more features in the parylene material layer to form a stencil, wherein depositing a parylene material is continued for a sufficient time such that the formed stencil may be used and reused at least five times without significant damage to the features of the stencil or to the stencil material.

Stencils and complexes described herein, e.g., stencil and substrate complexes, alone or with one or more of, e.g., a protective layer, a cell repulsive agent, a cell adhesive agent, are also contemplated.

A process for preparing a multilayer microfabrication stencil is also described. The process includes depositing a parylene material to form a first parylene material layer, depositing a layer of a material that improves stencil layer separability to form a first separation layer on the first parylene material layer, depositing a parylene material on the first separation layer to form a second parylene material layer, and creating one or more features in the parylene material layers to form a stencil. The process may also include depositing a layer of a material that improves stencil layer separability to form a second separation layer on the second parylene material layer, and depositing a parylene material on the second separation layer to form a third parylene material layer.

The first parylene material layer may be deposited on a substrate with a treated or untreated surface. The material that improves stencil layer separability may include a surfactant. The parylene material may include parylene-C.

An article is also described that includes a substrate, and a multilayer microfabrication stencil including one or more features and comprising two or more parylene layers, wherein each parylene layer is individually removable. In some aspects, the multilayer microfabrication stencil may be removed from the substrate and reversibly bonded to a second substrate without significant damage to the stencil or to features of the stencil.

Also described is a process of forming a complex biological microenvironment, including applying a multilayer microfabrication stencil to a substrate to form a first complex, incubating a first biomaterial over the first complex, incubating a second biomaterial over the first complex, removing a first layer of the multilayer stencil to form a second complex, incubating a third biomaterial over the second complex, removing a second layer of the multilayer stencil to form a third complex, and incubating a fourth biomaterial over the third complex. The process may also include removing a third layer of the multilayer stencil to form a fourth complex, and incubating a fifth biomaterial over the fourth complex. The biomaterial may include a protein or cell type. Each layer of the multilayer stencil may be formed from a material comprising parylene.

Also described is a process of forming a complex biological microenvironment, including applying a multilayer microfabrication stencil to a substrate to form a first complex, incubating a first biomaterial over the first complex, removing a first layer of the multilayer stencil to form a second complex, incubating a second biomaterial over the second complex, removing a second layer of the multilayer stencil to form a third complex, and incubating a third biomaterial over the third complex. The process may also include removing a third layer of the multilayer stencil to form a fourth complex, and incubating a fourth biomaterial over the fourth complex. The biomaterial may include a protein or cell type. Each layer of the multilayer stencil may be formed from a material comprising parylene.

The details of one or more embodiments are set forth in the accompanying drawings and the description below. Other features, objects, and advantages will be apparent from the description, drawings, and from the claims.

### DESCRIPTION OF DRAWINGS

The file of this patent contains at least one drawing executed in color. Copies of this patent with color drawings will be provided by the Patent and Trademark Office upon request and payment of the necessary fee.

FIG. 1 shows a stencil being peeled from a wafer after fabrication and scanning electron microscope images of the fabricated stencil.

FIG. 2 is a series of images of different protein patterns produced using the same parylene stencil repeated times.

FIG. 3 is a series of images showing the effects of HA coating on cell adhesion on the parylene membrane.

FIG. 4 is a schematic diagram of an embodiment of a protein or cell patterning process.

FIG. 5 is a series of fluorescent images of proteins patterned on (A) polystyrene, (B) methacrylated glass, and (C) curved PDMS.

FIG. 6 is a series of images showing cell patterning on a substrate before and after removal of a parylene membrane stencil.

FIG. 7 is a series of images showing cell patterning on PDMS formed using parylene stencils.

FIG. 8 is a schematic diagram of the process used to generate static and dynamic cellular co-cultures.

FIG. 9 is a series of images of static co-cultures produced using a reusable parylene membrane.

FIG. 10 is a series of images showing static co-cultures in the same microwells produced using a reusable parylene membrane.

FIG. 11 is a series of images of dynamic co-cultures produced using a reusable parylene membrane.

FIG. 12 is a graph showing the adsorption of fluorescein HA on different substrates normalized to a glass control (100%).

FIG. 13A is a graph showing the cell adhesion on a parylene-C stencil coated with FN, HA and collagen.

FIG. 13B is a graph illustrating cell adhesion on various parylene-C surfaces.

FIG. 14 is a graph showing the influence of the substrate on cell shape.

FIG. 15 is a series of fluorescent images of protein co-patterning on PDMS using a parylene stencil.

FIG. 16 is a series of images showing both light micrograph (left) and the corresponding fluorescent (right) images after steps in the formation of static co-cultures using parylene-C stencils.

FIG. 17 is a graph showing the recovery of a parylene membrane by plasma treatment.

FIG. 18 is a series of images showing both phase contrast micrograph (left) and the corresponding fluorescent (right) images of steps in the formation of dynamic co-cultures using parylene-C stencils.

FIG. 19 is a series of images showing the stability of mES cell patterns and mES/AML12 co-cultures over time using both phase contrast (top) and fluorescent (bottom) images.

FIG. 20 is graph illustrating contact angles for various materials and surface conditions of parylene-C stencils.

FIG. 21 is an illustration of a fabrication process for multilayer parylene-C stencil with microwell patterns.

FIG. 22 is a number of SEM images of multilayer parylene-C stencils.

FIG. 23 illustrates patterning of multiple proteins formed using a multilayer parylene-C stencil.

FIG. 24 is a schematic representation of a dynamic co-culture system using a multilayer stencil.

FIG. 25 is a series of fluorescent images illustrating steps in the formation of dynamic co-cultures using parylene-C stencils of various thicknesses.

FIG. 26 is a graph comparing the number of retained ES cells in the wells of multilayer stencils having various layer thickness combinations.

### DETAILED DESCRIPTION

Methods and materials for practicing an inexpensive and widely applicable micropatterning technology are described. Potential applications include use in high-throughput biological experiments and studies, biosensors, microfabrication, cell screening devices, combinatorial library screening, and fabricating tissue engineering templates. Also described herein is a method of fabricating dynamic co-cultures by using stencils that can be fabricated in a simple and cost effective manner, enabling widespread use in the biological community. For example, in addition to use with proteins and cells, this same technology and approach can potentially be applied to other biomolecules such as lipids and carbohydrates. The use of a portable and reusable stencil can make the process easy, convenient, and inexpensive to use and apply in a laboratory.

A robust and reusable microfabricated micro-patterning stencil may be formed and reversibly sealed on substrates to enable surface patterning. After use or patterning, the stencil may be removed from the surface and reused multiple times. Micropatterns having dimensions as small as 1 micron or less may be produced using these stencils. These micropatterns can be formed of proteins, cells, or other biomaterials. These micropatterns can include multiple proteins on surfaces as well as various cells including fibroblasts, hepatocytes, and embryonic stem cells.

Microfabrication stencils can be used to meet various technical requirements of engineering a cellular microenvironment. For example, stencils can serve as selective physical barriers, and may allow a substrate to be patterned with features of virtually any size or shape. In one embodiment, the stencil may be formed from a polymeric material. Examples of suitable polymeric materials include parylene and parylene-C. In one embodiment, the stencil may be formed from a hydrophobic material. In one embodiment, the stencil may be formed from a mechanically robust material. For example, the stencil may be formed from a mechanically robust material having a Young's Modulus of 1.0 GPa or greater, 1.5 GPa or greater, 2.0 GPa or greater, 2.5 GPa or greater, or 3.0 GPa or greater.

The stencil may be formed of a parylene-based material. A parylene-based stencil combines the advantages of being reusable and reversibly sealable together with strong biological and mechanical properties. Parylene is a biocompatible material, has desirable strength and durability, and has the required ability to form microstructures. Beneficially, a micro-patterning process may be repeated multiple times using the same stencil, as the parylene-based material is strong and durable.

In one embodiment, the stencil can be made from parylene-C (di-chloro-di-para-xylylene). Parylene-C is a biocompatible, inert, and non-degradable material, which can be used in fabricating a variety of microstructures. For example, parylene-C can be used to fabricate pin-hole free film, and it deposits conformally at room temperature in vacuum. It also has excellent bacterial and fungal resistance, and is extremely resistant to chemical attack. Parylene-C is also mechanically robust (having a Young's Modulus of 3.2 GPa) compared to PDMS (˜0.75 MPa), and is stiffer and more robust than other elastomer stencils. It is also very ductile, with an elongation to break of 200%. Therefore, a stencil formed using parylene-C can easily be removed or attached to a surface without tearing, and a parylene-C stencil can form reversible seals on various surfaces, including hydrophobic surfaces such as polystyrene and PDMS. As a lift-off process may be used in the absence of washing or other chemicals in preparing cultures, arrays, etc., the technology is compatible with chemically sensitive biomolecules.

Depending on the desired application, stencils may be produced with various thicknesses, and the thickness can be tailored for specific applications. In various embodiments, the stencil may have a thickness of at least 1 μm. For example, in typical cell and protein applications, the stencil may have a thickness equal to or greater than 3 μm, 5 μm, or 7 μm. Typically, the stencil may have a thickness equal to or less than 20 μm, 17 μm, or 15 μm. In one embodiment, the stencil may have a thickness from about 9 μm to about 11 μm. In another embodiment, the stencil may have a thickness of about 10 μm. The thickness of the parylene stencil, along with the size of the features in the stencil may be used to control the amount of the biomaterials deposited in the biomaterial patterns formed using the stencils. The stencil may be produced with sufficient thickness to enable cells to deposit in a well structure. The well structure may protect cells from washing away during a washing step. The stencil may be produced with sufficient thinness to enable multiple stencils to be stacked on top of each other, allowing multiple stencils to be initially placed on a substrate and then used in a series of process steps.

Depending on the desired application, a range of features (such as holes, lines, and other shapes) may be present in the stencil. These features are formed by creating voids in the stencil material layer. The size of these features can vary, based in the desired application. For example, microfabricated parylene-C stencils may contain holes and other features ranging in size from <1 μm to 1 cm. In one embodiment, holes or features will range from 40 μm to 200 μm in a stencil used to generate cell micropatterns.

The selectability of feature size and stencil thickness enables the stencil to have a range of uses. In addition, the surface characteristics of parylene, and the ability to modify those characteristics enable stencils made using parylene to have higher patterning resolution than elastomeric stencils (such as PDMS). The increased patterning resolution can be a significant advantage in certain applications, such as in making highly integrated chips.

A stencil may be prepared from parylene materials for use in various processes as described herein. A stencil may be produced using various fabrication techniques. In one embodiment, a parylene stencil may be fabricated on a wafer using techniques such as vapor deposition and dry etching. Subsequently, the stencil can be removed from the wafer and used directly in various processes, such as those described herein. The stencil may also remain on the wafer for some period of time before use, or the stencil may be removed from the wafer and stored for later use.

A wafer substrate may be prepared for deposition of the parylene material by cleaning the wafer. Various techniques may be used to clean the wafer, including acidic/oxidative liquid cleaning. After cleaning, the wafers may be coated with a material to facilitate the fabrication of the parylene stencil in some manner. For example, the wafers may be coated with a material to facilitate removal of the stencil from the wafer. In one embodiment, a silicon wafer may be used as the wafer substrate.

After cleaning, and other optional wafer preparation, the parylene material may be deposited onto the wafer. In one embodiment, a parylene material may be deposited by condensing a parylene vapor onto the wafer. For example, a multi-stage deposition process, including vaporization, pyrolysis, and deposition may be used to form a parylene layer.

After deposition of the parylene, a protective layer may be placed over the parylene. In one embodiment, a layer may be deposited onto the parylene layer. For example, a very thin metal layer (such as aluminum) may be used for the protective layer.

A photoresist layer may be deposited over the protective layer and exposed to define the desired patterns on the protective layer. Developing the photoresist may reveal the desired pattern. In one embodiment, developing the photoresist will wash away the photoresist in the desired pattern, exposing the protective layer under the areas of the pattern. After exposure, the protective layer may be removed in the desired pattern. In one embodiment, an etchant can be used to remove the protective layer from the desired pattern. For example, if a metal is used as the protective layer, a metal etchant can be used to remove the metal in the desired pattern.

The exposed parylene layer can then be removed in the desired pattern. In one embodiment, the parylene can be removed using Inductively Coupled Plasma (ICP) Reactive Ion Etching. The protective layer may act to protect the parylene not in the desired pattern.

After forming the desired pattern in the parylene material, the rest of the protective layer may be removed, leaving a parylene layer having the desired pattern on the wafer.

In addition to use in forming the desired pattern or features in the stencil, the photoresist can be exposed and developed in such a way to produce a number of shapes. In one embodiment, the outside edges of a polygon will be exposed. Generally, the polygon shapes will be squares or circles, though other shapes are possible. Following exposure and development, the protective layer may be removed from the shape edges, exposing the parylene layer under that shape. The exposed parylene membrane layer can be removed along with removal of the desired pattern in the parylene layer. This approach could allow production and separation of a number of parylene stencils from a single wafer.

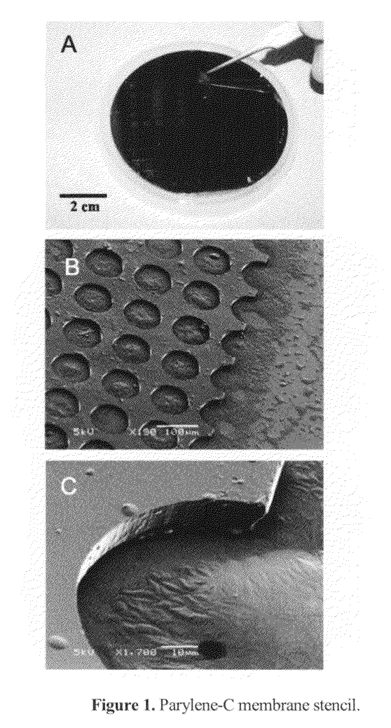

Individual parylene stencils can then be peeled from the wafer substrate for later use. For example, the stencils may be peeled off from the wafer substrate using fine-edge tweezers or a scalpel. FIG. 1A shows a single parylene stencil being peeled from a wafer substrate using sharp tweezers. The wafer includes a large number of square-shaped stencils, each having a desired pattern. FIGS. 1B and 1C show Scanning Electron Microscope (“SEM”) pictures of a single parylene stencil, at magnification levels X190 (FIG. 1B) and X1700 (FIG. 1C).

In the embodiment shown in FIG. 1, the desired pattern is a series of round holes in a grid pattern. FIG. 1 clearly shows a portable microstencil in which microscale patterns have been created during the fabrication stages. This makes the stencil quite convenient for use in research labs, as the stencil is pre-manufactured and ready for use. This approach saves time and requires less expertise for patterning proteins and other biomolecules, as reactive ion etching is not necessary in the lab at the time of use.

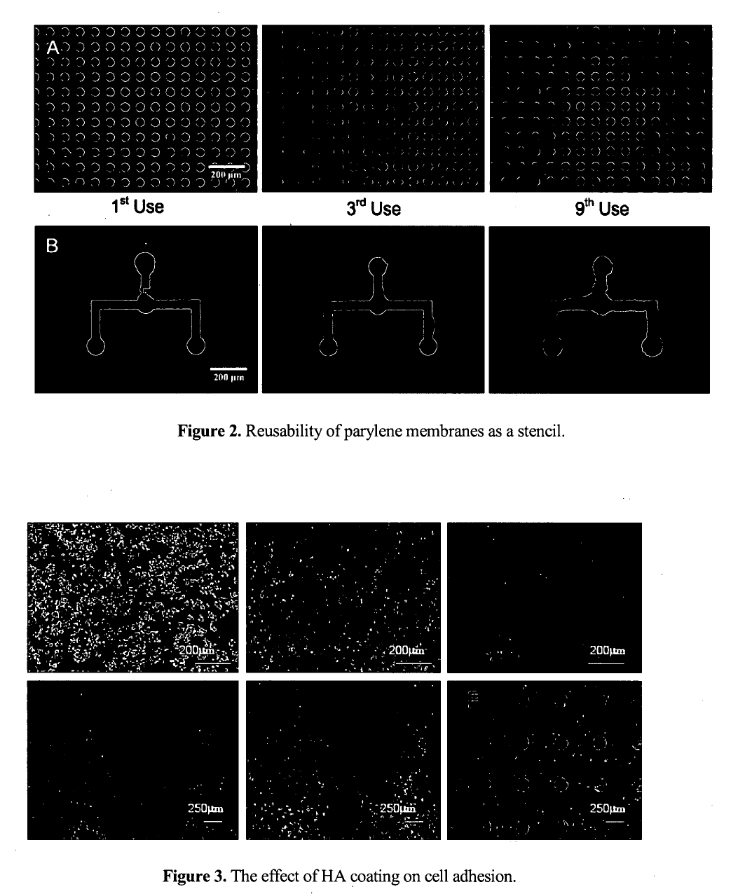

The parylene stencils enables the creation of precise micropatterns. The reusable parylene stencils may continue to provide a very good pattern that remains fairly precise for a number of uses. In various embodiments, a stencil may continue to provide a very good pattern for at least 3 uses, for at least 5 uses, for at least 10 uses, for at least 15 uses, for at least 20 uses, or more. FIG. 2 shows the results of a series of consecutive patterning processes using the same parylene stencil, with results shown after the first, third, and ninth uses. With adequate drying before each use, the parylene stencil adhered equally well for at least 10 uses. It was also possible to easily remove the stencil from a surface multiple times without damage to the pattern features of the stencil by using sharp tweezers after each use. In FIG. 2, protein FITC-BSA (stained green), was used to form patterns on PDMS (FIG. 2 A's) and on polystyrene (FIG. 2B's). The structural integrity of the stencil was preserved through the ten experiments, as evidenced by the nearly identical protein patterns produced. This reusability may make various experiments and processing less expensive than experiments run using single-use stencils. The ability of the stencil to be effectively used multiple times may be referred as using the stencil without causing significant damage to the features of the stencil or to the stencil material. Thus, use without causing significant damage includes the ability of the stencil to form a reversible seal with the substrate at each use, the ability to form essentially the same pattern at each use, and the ability to be treated in a similar manner during the process at each use. In effect, the stencil has minimal damage after each use such that the pattern is highly reproducible for at least the certain number of uses, as discussed above.

The stencil may be engineered to have various surface properties. The surface properties may be produced by a surface treatment applied during manufacturing of the stencil, or a surface treatment may be applied after manufacturing. In addition, a surface treatment may be applied during processing or use (i.e. during an experiment). Alternatively, the stencil may be produced and used without a surface treatment. For example, a plasma treatment may be used to increase the hydrophilicity of the stencil surface. Thus, in one embodiment, the stencil can be subjected to plasma treatment to increase the hydrophilicity of the stencil surface. In another embodiment, the stencil may not be subjected to plasma treatment, as the inherent cell-repulsive properties of a non-treated parylene stencil may be sufficient to achieve the desired performance.

In one approach, the surface of the stencil may be treated to be more cell-repulsive. For example, the surface may be treated with HA to make the surface more cell-repulsive than an untreated surface. An example of a HA coated stencil is shown in FIG. 3, which shows that cells rarely adhere to the HA coated stencil surface. The images shown in FIGS. 3A and 3B are images of a parylene stencil without HA coating after incubation with mES cells for 12 hours. The images shown in FIGS. 3C and 3D are pictures of mES cells over HA coated parylene stencils incubated for 12 hours. The random cells seen outside the parylene holes in FIGS. 3C and 3D are free cells which can be removed by washing. The images shown in FIGS. 3E and 3F are pictures of FIGS. 3C and 3D after washing and removal of the parylene stencil.

In another approach, the surface of the stencil may be treated to make the surface more cell-adhesive. For example, the surface may be treated with FN or collagen to make the surface more cell-attractive. In another approach, the stencil surface is initially untreated, and then treated later during use to make the surface more cell-adhesive

In another approach, the surface of the stencil may be treated to enable a change in surface properties during use. In one embodiment, the surface properties of the stencil may be initially modified to be cell-repulsive. Then, the initially cell-repulsive surface may be modified during use to be less cell-repulsive compared to the treated surface, or even cell-adhesive compared to an untreated surface. In one embodiment, FN may be added to a HA treated surface to make the surface less cell-repulsive. In one embodiment, collagen can be added to a stencil surface treated with HA to change the surface from cell-repulsive to cell-adhesive. For example, collagen may be used to adsorb on an HA treated surface and to change the surface properties from cell-repulsive to cell-adhesive due to its weakly cationic properties. In one embodiment, the surface properties of a stencil surface may be engineered by layer-by-layer deposition of HA, collagen, and/or FN.

It has been found that the surface of the parylene stencil that is not exposed to the reactive ion etching in the fabrication stage has better adhesive qualities compared to the side not directly exposed to the reactive ion etching. This more-adhesive surface is preferably used in forming a seal between the parylene stencil and substrate surface (as described later).

The parylene stencil may be recovered between uses. Following incubation and washing, the stencil typically retains some amount of the specimen used. Recovery of the stencil, including removal of residual cells or proteins by cleaning, enhances the reusability of the stencil, and enables reuse in additional different applications. Various cleaning techniques may be used. In one approach, the stencil may be cleaned using plasma cleaning. In one embodiment, the stencil may be cleaned by trypsinizing the stencils to remove residual cells. A cleaning method, such as plasma cleaning, should continue for a time sufficient to clean the stencil. In one embodiment, the stencil may be subjected to plasma cleaning for about 5 minutes, 10 minutes, 15 minutes, or more to remove residual proteins or cells. A description of stencil cleaning may be found in Example 8.

Applications of the reusable parylene-based stencil include use in high-throughput biological experiments and studies, biosensors, microfabrication, cell screening devices, combinatorial library screening, and fabricating tissue engineering templates. For example, the stencil can be used in protein patterning, or in cell patterning. As another example, the stencil can be used in creating cellular co-cultures, including both static and dynamic co-cultures.

The stencil is typically used in conjunction with a substrate. Various substrates may be used. In one embodiment, the substrate can be hydrophobic. Examples of suitable hydrophobic substrates include PDMS, polystyrene, and acrylated and methacrylated glass. Other potential substrates include glass and silicon. Although the substrates are typically flat, they may also be curved or shaped, as the parylene stencil is flexible and has the ability to follow and adhere to the contours of a shaped substrate. The flexibility of parylene can be utilized in using a stencil to fabricate patterns on non-planar surfaces.

The substrates may be prepared prior to use. Typically, preparation will include cleaning and drying. The substrates may be cleaned by known methods, including various liquid cleaning techniques. After cleaning, the substrates may be coated with a material to affect the subsequent processing. For example, the substrate may be coated or treated with a material (such as FN) to improve cell-adhesion on the substrate. In one embodiment, the surface of the stencil may be treated before application of the stencil to the substrate. In one embodiment, the surface of the substrate may be treated in conjunction with the treatment of the stencil surface after application of the stencil to the substrate. In one embodiment, the exposed surface of a substrate may be treated after removal of the stencil from the substrate. In one embodiment, the substrate may be coated or treated with a material to improve adhesion of the stencil on the substrate.

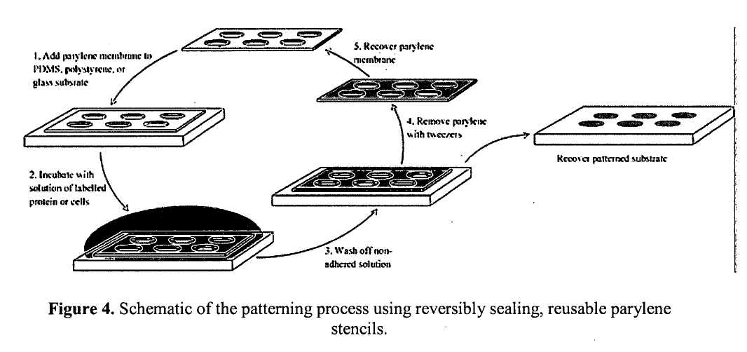

FIG. 4 is a schematic diagram of one embodiment of a protein or cell patterning process.

A method 401 will be described in reference to a patterning system that utilizes a reusable parylene stencil. The method begins with application 410 of a clean parylene stencil 491 to a substrate 493. A pre-fabricated parylene stencil 491 is brought into conformal contact with a substrate 493, and pressure applied to form a seal between the stencil 491 and the substrate 493.

After placing the stencil on the substrate, a specimen of interest can be incubated 420 over the substrate and stencil for a definite period, allowing the specimen to adsorb on the substrate surface. Generally, incubation will be allowed to continue for the time needed for the protein to adhere to the surface. In one embodiment, the specimen of interest may be a protein. Examples of suitable proteins include serum albumins such as bovine serum albumin, collagen, fibronectin, insulin, proinsulin, human growth hormone, interferon, a-1 proteinase inhibitor, alkaline phosphotase, angiogenin, cystic fibrosis transmembrane conductance regulator, extracellular superoxide dismutase, fibrinogen, glucocerebrosidase, glutamate decarboxylase, human serum albumin, myelin basic protein, soluble CD4, lactoferrin, lactoglobulin, lysozyme, lactoalbumin, erythropoietin, tissue plasminogen activator, antithrombin III, prolactin, and a1-antitrypsin. In one embodiment, the specimen of interest will be one or more cells. In one embodiment, the specimen of interest will be a lipid or other biomaterial.

After incubation, the non-adhered material is optionally washed 430 from the stencil/substrate. Various liquids, or combinations of liquids, may be used for washing. Examples of suitable liquids that may be used for washing include water, PBS, and saline.

Following washing, the parylene stencil may be removed 440 from the substrate, revealing a specimen pattern 495 on the surface of the substrate 493.

The parylene stencil 491 may then be recovered 450. Following incubation and washing, the stencil typically retains some amount of the specimen of interest after removal of the stencil from the substrate. Recovery of the stencil, including removal of residual cells or proteins, enables the stencil to be reused in additional applications. In one embodiment, the parylene stencil is recovered by submitting the parylene stencil to plasma cleaning, as described earlier.

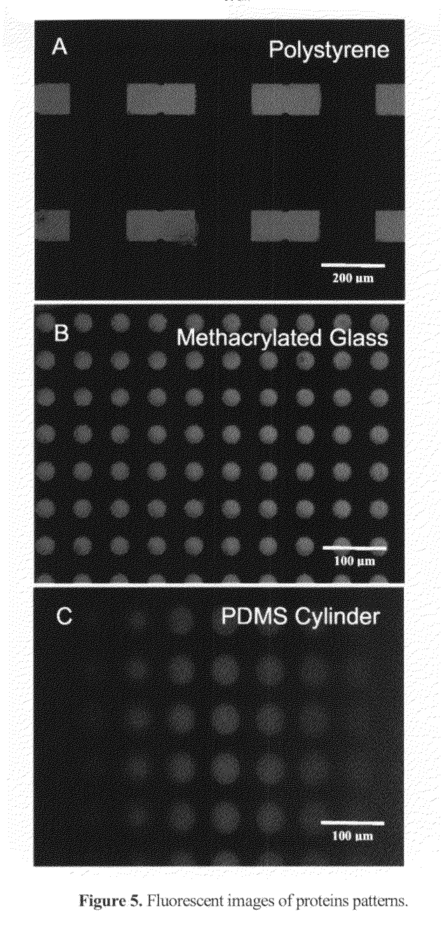

Various examples of protein patterning are shown in FIG. 5. Proteins were prepared as described in Example 6. Following incubation and washing, the stencil was removed, and the pattern revealed. FIG. 5A shows FITC-BSA proteins patterned on polystyrene in indented rectangular shapes. FIG. 5B shows TR-BSA proteins patterned on methacrylated glass in circular shapes in an array.

An advantage of the stencil based surface patterning is that it can be applied to curved surfaces. A parylene stencil was wrapped over a cylindrical PDMS slab (8.5 mm in diameter) and FITC-BSA was incubated on the surfaces. Removal of the stencil revealed protein patterns formed on the curved surface. This is illustrated in FIG. 5C, which shows FITC-BSA proteins patterned on a PDMS cylinder in an array of circular shapes.

Patterned proteins have various applications in research labs and in diagnostics. For example, protein patterning enables high-throughput experiments, thereby reducing the time required for various research and investigative projects. In addition, these processes reduce the work required (both time and technique) by the investigator.

In one embodiment, a protein co-pattern may be produced by following the above steps with minor modifications. After the first incubation 420 with a protein, and subsequent washing 430, a second protein may be incubated over the substrate. Thus, a co-pattern with two different proteins can be obtained by patterning a first protein and then incubating a second protein over the patterned substrate surface for a defined period of time and then washing as described above. After washing, the stencil may be removed, leaving a protein co-pattern on the substrate.

The steps described above may also be conducted with multiple proteins and/or multiple stencils. In one embodiment, this may form a co-pattern with multiple proteins. In one embodiment, this may form a complex arrangement of different patterns of proteins. In one embodiment, more than one parylene stencil may be used, with one or more proteins incubated after the removal of each parylene stencil. In one embodiment, multiple proteins may be incubated sequentially or simultaneously over a substrate/parylene stencil complex. For example, a combination of two proteins may be grown over a substrate/parylene stencil complex, the stencil may be removed, and then one or more additional proteins incubated over the substrate and patterned proteins. In one embodiment, the substrate or stencil may be treated between incubations to modify the surface properties of the stencil or substrate.

Patterned cellular arrays can be used in studying cell shape, cell migration, and morphogenesis and cell growth. These studies can be used in exploring cell functions and properties, and for producing data useful in tissue engineering sciences. Cell arrays can also be used in cell-based cytotoxicity studies for drug research.

In general, a patterned cellular array may be formed in similar manner to protein patterning. As shown in FIG. 6, this process is very versatile and yields precise patterns. The method includes placing a parylene stencil on a substrate. Then, the cells of interest are incubated on top of the parylene membrane. FIG. 6A shows an example of NIH-3T3 cells on top of a stencil/substrate following incubation. The cells adhere to the surface in a specific range of time depending upon various factors, including cell type, substrate type, the presence or absence of surface treatments, the stencil pattern size, etc. Generally, incubation will be allowed to continue for the time needed for the cells to adhere to the surface. Cell adhesion may optionally be confirmed through observation under a microscope before proceeding. Examples of suitable cells include fibroblasts, hepatocytes, endothelial cells, epithelial cells, myoblasts, keratinocytes, glial cells, neural cells, and stem cells. Following incubation, the stencil/substrate may be washed with a liquid (such as water, PBS, or saline) to remove excess materials including free-floating cells. The parylene membrane may then be peeled off with tweezers to obtain a pattern of cells that remain adhered to the substrate. FIG. 6B shows the same substrate and cells as in FIG. 6A, following washing and removal of the stencil.

These techniques also enable precise patterns of single cells, and patterns having one cell per microhole in the parylene membrane may be produced. FIG. 6C shows a NIH-3T3 pattern after removal of the parylene stencil where one cell was patterned per hole in the stencil. Similar cellular patterns can be obtained with different type of cells, including mES cells, AML12 cells and NIH-3T3 cells.

One factor in the generation of robust cell patterns is the size of the holes in the parylene pattern. In general, higher pattern integrity was achieved with larger stencil features (>200 μm diameter) because cells, especially fibroblasts, elongate when they attach to a substrate, often stretching across or attaching to both the parylene and the substrate. Despite this, it was possible to produce an array comprised of single cells by optimizing the pattern feature size. A parylene stencil with 20-60 μm, or about 40 μm, diameter circles may be used for creating single cell arrays of NIH-3T3 cells after the parylene stencil is lifted off. The size of the circles, or holes, may vary depending on the cell used to form the single cell array.

In various embodiments, various treatments, including treatment with cell adhesion promoters (such as fibronectin or collagen), may be used to alter or improve the stencil or substrate surface in some manner. If used, a treatment may be applied using various approaches. For example, a cell-adhesion promoter may be applied by incubation over a stencil-substrate complex, allowing the promoter to adsorb onto the surface before the cells are dispensed over it. As another example, the substrate surface may be pre-coated with a cell-adhesion promoter prior to application of the stencil to the substrate.

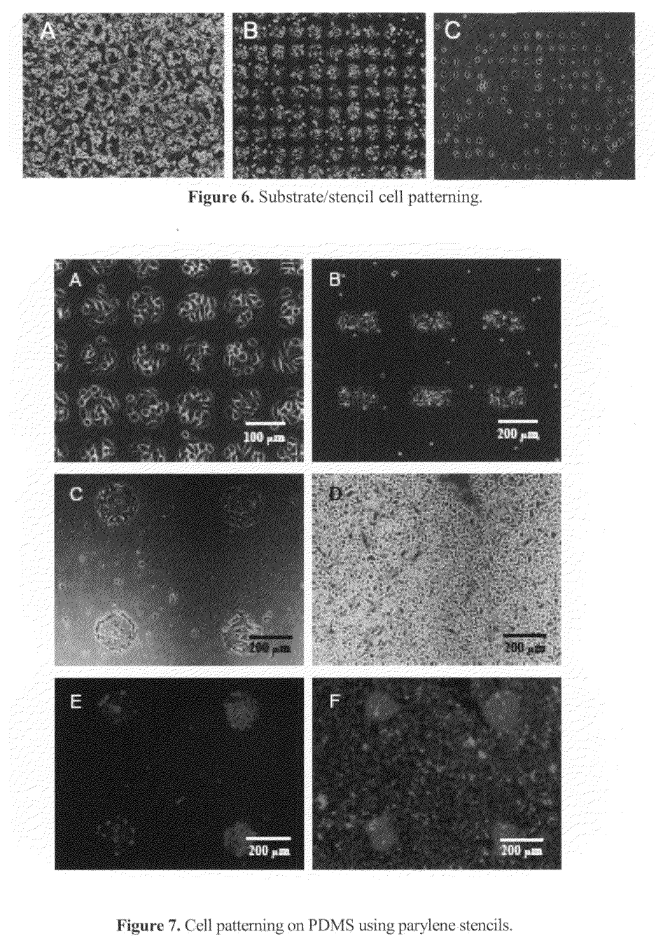

FIG. 7 shows various cell patterns over a FN-treated PDMS substrate. Phase-contrast images of patterned NIH-3T3 fibroblast cells after removal of the stencil are shown in FIG. 7A (array of circular shapes) and 7B (rectangles). Phase-contrast and fluorescent images of a circular shape pattern of AML12 hepatocyte cells (stained blue as described in Example 5) are shown in FIGS. 7C and 7E. NIH-3T3 cells (stained red as described in Example 5) are incubated over the cells shown in FIGS. 7C and 7E, forming a static co-culture of cells, described in more detail below. The resulting co-cultures are shown in FIGS. 7D (phase-contrast) and 7F (fluorescent).

In addition to simple cell adhesion, patterned cellular co-cultures can be generated with controlled spatial and temporal resolution by the incubation of various cells combined with the use of mechanically robust, microfabricated parylene stencils. The ability to engineer and modify the surface properties of a parylene stencil, as described earlier (such as a reversible change from cell-repulsive to cell-adhesive) may be beneficial in forming patterned co-cultures. In particular, static co-cultures can be fabricated by seeding primary cells in the open holes or pattern of a microstencil, and then seeding support cells on the regions beneath the stencil once it has been removed. Alternatively, dynamic patterned co-cultures can be generated using stencils by seeding the primary cell type in the open holes of the stencils, and then seeding the support cells on the surface of the stencil. The support cells can be removed while maintaining the primary cell type in place by removing the parylene stencil. Subsequently, a secondary support cell type can be co-cultured with the first cell type to form a dynamic co-culture.

Patterned co-culturing is a method of controlling the micro-scale location of two different cell types in vitro, and can be a factor in mimicking the cell-cell interactions of in vivo systems, such as spatial signaling and the degree of homotypic/heterotypic contact. Static and dynamic co-cultures can significantly enhance the capabilities of controlling the cellular microenvironment for stem cell and tissue engineering studies. For example, patterned stem cells can be used in the study of the stem cell differentiation. In addition, cell shape has been found to influence the stem cell fate. The technology can be used to confine individual cells to particular shapes and this can help the researchers to follow them in real time.

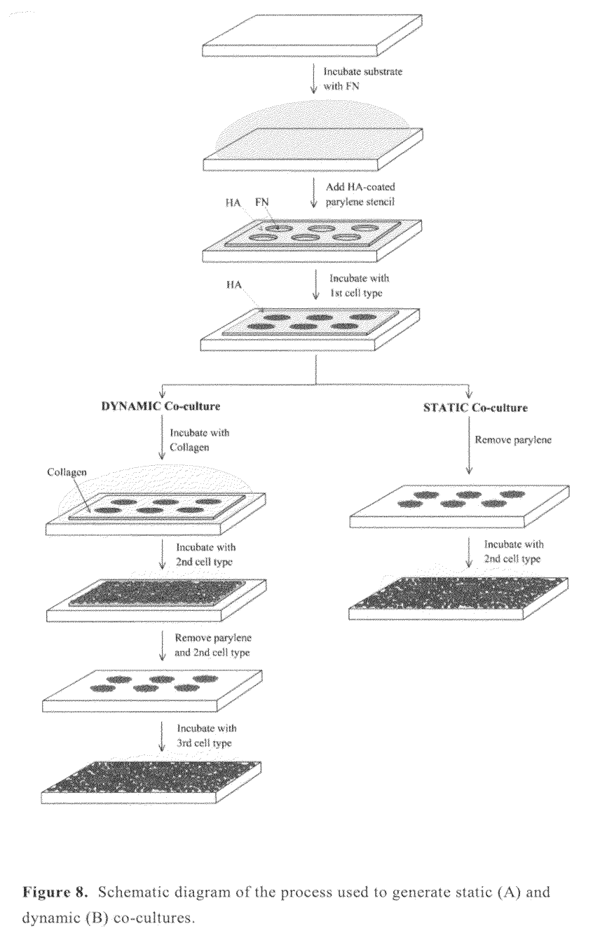

FIG. 8 is a schematic diagram of various embodiments of a cellular co-culture process. Two methods of creating patterned co-cultures using parylene stencils are described, exhibiting cell-cell interactions that can be controlled in a static or dynamic manner. Static co-cultures may be fabricated to control the degree of homotypic and heterotypic cell-cell interactions. Dynamic co-cultures may be fabricated to control the temporal sequence of the cell-cell interactions in patterned co-cultures. Thus, the use of microfabricated, biocompatible, and mechanically robust stencils is a potentially versatile and inexpensive method of studying the degree as well as the dynamics of cell-cell interactions in tissue culture.

A parylene stencil can be used to produce a static co-culture, as shown in FIG. 8. Static co-cultures may be used in tissue engineering research as cells generally exhibit better growth when cultured jointly with their accessory cells that are present in-vivo. For example, it has been found that hepatocytes exhibit their maximum functionality when grown along with their accessory cell fibroblasts. In addition, since cues from surrounding cells influence cell behavior, cells in co-culture with support (i.e. feeder) cells preserve their phenotype similar to the cells in the body. For example, hepatocytes co-cultured with fibroblasts have been shown to produce liver specific enzymes in proportion to the density of fibroblasts. Thus, static co-cultures generated using the described approach can be useful in providing a tissue-like environment for drug assays and for improved tissue culture systems, as well as for other purposes.

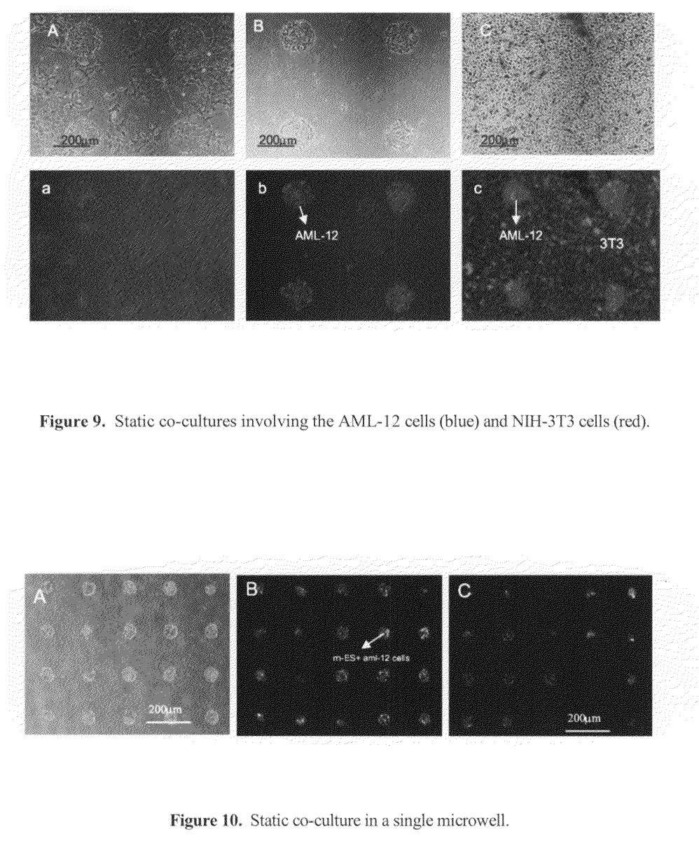

In general, static co-cultures may be obtained by a process similar to the steps for normal cell patterning as described above, followed by the incubation of a different cell type over the existing pattern. An example of a static co-culture is shown in FIG. 9. First, AML-12 cells (stained blue as in Example 5) are incubated over a stencil, with the results shown in FIG. 9A (phase contrast) and 9a (fluorescent). After removal of the stencil, the cells form a pattern on the substrate, as shown in FIGS. 9B and 9b. Then, NIH-3T3 cells (stained red as in Example 5) are incubated over the cell pattern and substrate. The results are shown in FIGS. 9C and 9c.

The details of obtaining patterned static co-cultures are described below.

First, a substrate 803 is selected and prepared 810 for use. In one embodiment, the substrate 803 is prepared by cleaning and drying before use. In one embodiment, the substrate 803 may be cleaned and then coated or incubated with a material to facilitate processing. For example, the substrate may be coated or incubated with a material (such as FN) to improve the cell-adhesive properties of the substrate. This pre-coating may make it easier for the second seeded cells to adhere to the areas surrounding the first cell pattern. In general, various substrate materials can be used. In one embodiment, the substrate will be hydrophobic. Examples of suitable hydrophobic substrates include PDMS, polystyrene, and acrylated and methacrylated glass. Other potential substrates include glass and silicon.

After preparation of the substrate 803, a pre-fabricated parylene stencil 801 is brought into conformal contact 820 with the prepared substrate 803, and pressure applied to form a seal between the stencil 801 and the substrate 803 to form a complex.

After placing the stencil on the substrate, the complex is placed in a well, and a first cell type can be incubated 830 over the substrate and stencil for a definite period, allowing the cell to adsorb on the substrate surface. Various cell types may be incubated as the first cell type. In one embodiment, a first cell type is a stem cell. An example of a suitable stem cell is a mouse embryonic stem cell (mES). The cells can be incubated for the time needed for the cells to adhere to the surface. Generally, the time required will be from 1 hour to 24 hours. In one embodiment, the time may be in the range of 3 to 7 hours. Cells can be seeded into the well at appropriate density to uniformly adhere to the surfaces of the substrate exposed through the holes or other structures in the parylene stencil. Cell adhesion can be checked by use of a microscope or other technique.

Following incubation with the first cell type, the stencil and substrate may optionally be washed 835. This may remove excess material from the surface of the substrate and stencil. Various liquids, or combinations of liquids, may be used for washing. Examples of suitable liquids that may be used include water, PBS, and saline.

Then, the stencil 801 may be removed 840 from the substrate. This leaves a pattern 805 of the first cell type on the substrate 801.

Following removal, a second cell type may be incubated 850 over the patterned first cell type. This enables co-culturing of a first cell type with a second cell type. The cells can be incubated for the time needed for the cells to adhere to the surface. Generally, the time required will be from 1 hour to 24 hours. In one embodiment, the incubation time may be for more than 12 hours. In one embodiment, mES cells (first cell type) may be co-cultured with fibroblasts or hepatocytes (second cell type) following removal of the reversibly sealed stencil from the substrate.

Following the second incubation 850, the substrate and cell co-culture may be used in a variety of methods.

In addition, the parylene stencil 801 may then be recovered 860 after removal from the substrate 803. Following incubation and washing, the stencil typically retains some amount of cells and other materials after removal of the stencil from the substrate. Recovery of the stencil, including removal of residual cells, enables the stencil to be reused in additional applications. In one embodiment, the parylene stencil is recovered by submitting the parylene stencil to trypsin cleaning. A cleaning method, such as trypsin soaking, should continue for a time sufficient to clean the stencil. In addition, another cleaning method, such as plasma cleaning, may also be used.

In another embodiment of a static co-culture, two or more cells may be incubated in the same structure or pattern, providing the ability to obtain a patterned static co-culture of two different cells in a single shape in the pattern. The cells may be incubated simultaneously or sequentially, but the stencil is generally not removed until after the incubation of all cells. FIG. 10 shows a static cellular co-culture in single microwells. mES cells (stained green according to Example 5) and AML12 cells (stained red according to Example 5) were co-cultured over the same stencil. FIG. 10A (phase contrast) and FIGS. 10B and 10C (fluorescent) show the co-cultures 24 hours after incubation.

In one embodiment shown in FIG. 8, a parylene stencil can be used to produce a dynamic co-culture. The parylene stencil and described process can be used to enable researchers to analyze the impact and importance of a specific type of a mature cell's interaction with stem cells.

First, a substrate 803 is selected and prepared 810 for use. In one embodiment, the substrate 803 is prepared by cleaning and drying before use. In one embodiment, the substrate 803 may be cleaned and then coated or incubated with a material to facilitate processing. For example, the substrate may be coated or incubated with a material (such as FN) to improve the cell-adhesive properties of the substrate. In general, various substrate materials can be used. In one embodiment, the substrate will be hydrophobic.

Examples of suitable hydrophobic substrates include PDMS, polystyrene, and acrylated and methacrylated glass. Other potential substrates include glass and silicon.

After preparation of the substrate 803, a pre-fabricated parylene stencil 801 is brought into conformal contact 820 with the prepared substrate 803, and pressure can be applied to form a seal between the stencil 801 and the substrate 803 to form a complex.

After placing the stencil on the substrate, the complex is placed in a well, and a first cell type can be incubated 830 over the substrate and stencil for a definite period, allowing the cell to adsorb on the substrate surface. Various cell types may be incubated as the first cell type. In one embodiment, a first cell type is a stem cell. An example of a suitable stem cell is a mouse embryonic stem cell (mES). The cells can be incubated for the time needed for the cells to adhere to the surface. Generally, the time required will be from 1 hour to 24 hours. In one embodiment, the time may be in the range of 3 to 7 hours. Cells can be seeded into the well at appropriate density to uniformly adhere to the surfaces of the substrate exposed through the holes or other structures in the parylene stencil. Cell adhesion can be checked by use of a microscope or other technique.

Following incubation with the first cell type, the stencil and substrate may optionally be washed 835. This may remove excess material form the surface of the substrate and stencil. Various liquids, or combinations of liquids, may be used for washing. Examples of suitable liquids that may be used include water, PBS, and saline.

The surface of the stencil may then optionally be modified 870. In one embodiment, the surface characteristic of the stencil may be modified from cell-repulsive to cell-adhesive. For example, the stencil may be treated or incubated with a material to modify the surface characteristic of the stencil. Examples of materials that may be used to modify the surface characteristics of the stencil include collagen, HA, and FN.

Following optional modification 870, a second cell type may be incubated 875 on the stencil and substrate. In one embodiment, the second cell type will grow on the modified stencil surface. Various cell types may be incubated as the second cell type. In one embodiment, a second cell type is a fibroblast or hepatocytes. An example of a suitable fibroblast cell type is NIH-3T3, and an example of a suitable hepatocyte cell type is AML12. The cells can be incubated for the time needed for the cells to adhere to the surface. Generally, the time required will be from 1 hour to 24 hours. In one embodiment, the time may be in the range of 3 to 7 hours.

Following incubation with the second cell type, the stencil and substrate may optionally be washed 880. This may remove excess material from the surface of the substrate and stencil. Various liquids, as described above, may be used for washing.

Then, the stencil 801 may be removed 885 from the substrate 801. This leaves a pattern 807 of the first cell type on the substrate 801.

Following removal of the stencil 801, a third cell type may be incubated 890 over the patterned first cell type. This enables co-culturing of a first cell type with a third cell type. In one embodiment, mES cells (first cell type) may be co-cultured with fibroblasts or hepatocytes (third cell type) following removal of the reversibly sealed stencil from the substrate. The cells can be incubated for the time needed for the third cell type cells to adhere to the surface. Generally, the time required will be from 1 hour to 24 hours or more. In one embodiment, the incubation time may be for more than 12 hours. In one embodiment, the incubation time may be for more than 24 hours.

The parylene stencil 801 may be recovered 860 after removal from the substrate 803. Following incubation and washing, the stencil typically retains some amount of cells and other materials after removal of the stencil from the substrate. Recovery of the stencil, including removal of residual cells, enables the stencil to be reused in additional applications. In one embodiment, the parylene stencil is recovered by submitting the parylene stencil to plasma cleaning. A cleaning method, such as plasma cleaning, should continue for a time sufficient to clean the stencil. In one embodiment, the stencil may be subjected to plasma cleaning for about 5 minutes or more to remove the residual proteins or cells. In one embodiment, trypsin can be used to clean the stencil by removing the cells

Following the second incubation 890, the substrate and cell co-culture may be used in a variety of methods.

Other approaches to forming a dynamic co-culture may also be used. In one embodiment, stem cells can interact with a defined cell type for a particular period of time, followed by exposure to another cell type. For example, various dynamic co-cultures can be generated in various sequences using NIH-3T3, AML12, and mES cells. In one embodiment, the interaction of mES cells with AML12 cells may produce changes in the mES cell at the molecular level. These conditioned cells might then exhibit different behavior when exposed to NIH-3T3 cells. The duration of exposure to each cell type and the sequence of the cell types interacting with the mES cells can be varied making dynamic cellular co-culture methods a versatile tool in studying the dynamics of cell-cell interactions.

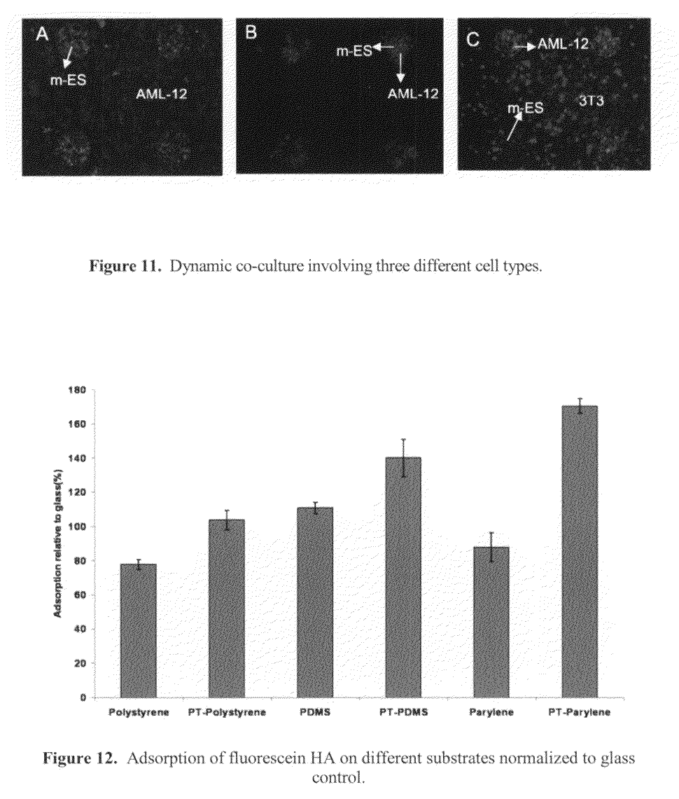

In another embodiment, second cell type may be incubated for a longer period of time, allowing some of the second cell type to seed in the pattern including the first cell type. Then, after the parylene stencil is removed, some of the second cell type remains in the cell pattern. When the third type of cells is incubated, a complex co-culture is formed including three different cell types. An example of this is shown in FIG. 11. mES cells (red) were first incubated, followed by incubation of AML12 cells (green) for at least 12 hours. FIG. 11A shows the stencil and substrate following 12 hours of incubation, while FIG. 11B is the same substrate and cell pattern following washing and removal of the stencil. NIH-3T3 cells (blue) were then incubated over the cell pattern, with the result shown in FIG. 11C.

Similar methods may be followed, but with the addition of additional steps for the incubation of additional cell types. In one approach, these additional cell types may be incubated for a time sufficient to allow for some interaction followed by complete removal (as described generally). In one approach, a similar approach to that shown in FIG. 11 may be followed, with some cell types remaining for later steps, allowing the interaction of additional cell types

Dynamic co-cultures can be a useful tool in stein cell research, as researchers can use dynamic co-cultures to study stem cell-mature cell interactions as well as interactions among various types of mature cells. This enables improved study of stem cell differentiation and for generating improved tissue culture systems. For example, stem cell niches have complex architecture and spatial orientation of cells together with intricate communications with adjacent cells of various mature types. It is believed that stem cell-mature cell interactions may be of particular importance. The sequence of events that lead to the stem cell fate decisions can be elucidated by studying the stem cell-mature cell interactions prior to stem cell differentiation. This type of study requires an in-vitro model with the ability to control the type, temporal sequence, and duration of the cell-cell interactions. Thus, a dynamic cellular co-culturing method is a promising approach in engineering the complexity of cell-cell interactions in tissue culture in a spatially and temporally regulated manner.

In one embodiment, the protein and cell patterning technology described herein can be combined together. Thus, one or more cell types can be incubated in a series of steps with one or more proteins to form a complex in vitro environment. In on embodiment, two different cell types are sequentially cultured to form a cell pattern, and after removal of the stencil, a protein is cultured over the substrate including the cell co-culture. Additional proteins and cells may additionally be cultured over the cells and protein. A similar approach may be used to produce a combination of various cells, proteins, lipids, and other biomaterials that have been cultured in a series of steps onto a substrate.

In one embodiment, the protein and cell patterning technology described herein can be incorporated on chips in microscale. These chips can be used in the labs by researchers involved in various basic biological and life science research. These chips can also be used by pharmaceutical companies involved in drug research. For example, the chips can be used for conducting multivariate analysis. Identifying a single drug candidate molecule may involve millions of independent chemical assays. With the potential for conducting several assays in a single chip, the processes described herein could greatly reduce the cost and increase experimental speed, potentially making research faster and commercial products cheaper.

The technology can be potentially used in biosensors to pattern the enzyme or proteins and can be used in detecting in specific molecules or pathogens. For example, the enzyme glucose oxidase can be patterned on a chip using this technology and can be used to detect glucose in the body fluids. Likewise, antigens of a pathogen can be patterned on the chips and this can be potentially used to detect the antibodies to that particular pathogen in the blood of the patients. By incorporating antigens of multiple pathogens in a single chip, it would be possible to screen for a multitude of infectious agents making diagnostics cheaper and simpler.

In general, for the reasons discussed earlier, controlling the extracellular microenvironment in a temperospatially regulated manner has significant advantages in the study of cell-cell interactions in general and stem cell differentiation in particular. Furthermore, the ability to control interactions dynamically can be particularly useful in some applications. An approach that utilizes layer-by-layer surface modifications combined with multilayer stencils (such as multilayer parylene-C stencils), offers an approach and means to dynamically control cell-cell interactions.

In one approach, multilayer parylene stencils can be designed and fabricated by depositing or inserting a thin film of a material that improves the separability of the adjacent parylene layers to form a separation layer. One example of a material that improves separability of the adjacent paraylene layers is a surfactant (such as a detergent, etc.) between adjacent parylene layers. The resulting stencil will then consist of individually peelable layers of stencil. For example, a parylene multilayer stencil may include a number of layers (2, 3, or more) with defined thicknesses (such as, for example, 5 microns, 10 microns, etc.). A separation layer between each pair of parylene layers improves the separation characteristics of the parylene layers adjacent to each separation layer, such that each parylene layer may be individually removed or peeled. In addition, the thickness of the individual layers may be individually controlled when producing the multilayer stencil, with the resulting ability to form stencils having layers of different thicknesses in various combinations. The layers of the multilayer stencil are individually peelable and separable.

A multilayer stencil may be used in a multi-step process for the generation of dynamic protein and cell co-patterns. For example, a single layer stencil may be used to create a co-pattern of two cell types or proteins. However, a multilayer stencil may be used to in many additional ways—for example, more cell types may be included and used in forming the dynamic co-cultures, or the seeding and propagation of various cells may be temporally adjusted and modified, or both, and further additional benefits of using multiple layers may be present under various conditions due to the increased flexibility provided by multiple layers. For example as shown in the examples, sequential co-cultures with at least 4 different cells (ES cells cultured with HUVECs, ALCs, NIH-3T3 cells, and HL-1 cells) have been achieved utilizing the multilayer stencil dynamic co-culture system.

The influence of the thicknesses of the individual layers may also be varies for different purposes. For example, the thickness of the layer affects the number of cells retained inside microwells during co-culture. Changing the heights of the individual layers may be done to enable optimizing the retention of cells within the pattern.

A multilayer stencil may be used for patterning proteins. As an example, after protein coating, the top layer of the stencil may be removed, leaving a precise protein pattern. The initial protein patterning may fully coat the bottom of the microwells formed by the stencil, making it resistant to further protein deposition. Accordingly, this enables co-patterns of proteins to be formed without deposition of the co-patterned proteins in the microwells. The initial protein pattern will remain stable and retain integrity as additional layers are peeled away, as the microwells fully retain their position and location on the substrate surface as the additional layers are removed. Protein deposition patterns can also easily be varied by changing the geometry of the stencil. The technology further allows for the generation of dynamic co-patterns of multiple proteins. Selective patterning of proteins such as antibodies and enzymes, for example, has recently attracted much interest for the study of specific protein-protein interactions and the development of diagnostic kits, protein sensors, and protein chips. Multilayer parylene-C technology might find application in this rapidly developing field of selective protein patterning.

A multilayer stencil may be used for dynamic cellular co-cultures. For example, a 3-layer stencil may be used to process a dynamic co-culture involving 5 different cell types. After seeding the microwells with cells, a layer-by-layer deposition approach using collagen (applied to restore cell adhesive properties to the top stencil surface) may be used. Surface switching of parylene-C from cell-repellent to cell-adhesive has been previously described above and may be used for selective cell patterning. In particular, sequential switching of adhesive properties of the top layer of the parylene-C stencil enables use of a pattern or sequence of secondary cell types around (but not within) the cell-containing microwells. For example, after each co-culture step, the secondary cell type may be successfully removed by peeling off the next membrane layer. Throughout this process, the original cells deposited remain inside the microwell pattern.

An increasing microwell depth can increase the level of protection for the original cell deposition, thereby increasing the number of cells retained after a series of co-cultures. Thus, the layers of the stencil may be modified as desired to affect the cell retention after each co-culture stage. The effects of layer thickness are illustrated an discussed in more detail in Example 16 below.

Cellular cross-talk—such as cell-cell interactions and cell communication via soluble factors—has fundamental importance in cell biology. Precise control of the cellular microenvironment and well-defined and flexible co-culture systems are crucial for studying such cross-talk. For some purposes and applications, dynamic cellular co-culture control would be particularly useful. For example, conditioning ES cells through sequential exposure to various heterotypic cells or secreted factors has been used in various stem cell differentiation protocols.

Multilayer parylene-C stencils can be used in, and are particularly useful for, co-culturing a sequence of multiple cell types with microscale control over the location of these cells. The described multilayer technology is flexible and the temporal aspect of the co-culture can be varied (as can the order of exposure to secondary cell types). Additionally, combined selective patterning of proteins and cells onto individual parylene-C stencils offers the opportunity to match each secondary cell type to an appropriate ECM environment.

A microfabricated multilayered stencil may be used for engineering the cellular microenvironment. The layers may be formed from parylene-C, and the parylene-C layers may be separated by another layer to facilitate separation or peelability. The developed stencils can be selectively patterned with different proteins and cells at the microscale level with spatiotemporal control. The number of layers may be modified depending on the co-culture process/application desired. In addition, the multilayer stencil is very flexible, overcomes constraints of existing co-culture systems, which are mostly limited to two different cell types, and the stencils may be adjusted to modify parameters of a co-culture system. For example, the pattern and the height of the layers of the parylene-C stencil can be varied, perhaps to yield increased interaction with secondary cell types. Furthermore, selective protein adsorption can be performed in combination with cell patterning. This might be important for creating co-cultures in which each cell type can be matched with an optimal ECM. As another example, reducing the dimensions of stencil features allows for the patterning of single cells, which might be useful for studying a series of different cell-cell interactions at a single cell level.

The simple and robust approach described for patterning proteins, cells, and other biomolecules and biological materials using the reversible adhesion of microfabricated parylene stencils and/or multilayer stencils has a wide range of uses. In general, the technique is simple, versatile, and inexpensive, and it may find potential use in various applications, including studying stem cell differentiation, developmental processes, wound healing, and pathogenic processes. A few of the potential products and applications include:
Protein chips for multivariate analysis and combinatorial library screening in research labs and pharmaceutical industry;
High-throughput experimentation;
Cell, protein, and other biomaterial arrays for use in research (i.e., biologists involved in basic biological research);
Patterned cells for the study of the stem cell differentiation;
Static and dynamic co-cultures for researchers involved in stem cell research and tissue engineering;
Diagnostics; and

Patterned enzymes in chips as biosensors for detecting specific biomolecules (such as toxins, glucose, etc.).

### Materials and Methods

### Materials

All tissue culture media and serum were purchased from Gibco Invitrogen Corporation (Carlsbad, Calif., USA) unless otherwise noted.

Pluripotent murine embryoinic stem (ES) cells (R1 strain) were obtained from Mount Sinai Hospital (Toronto, Canada).

Murine epithelial ameloblast-lineage cells (ALCs) were obtained from Dr. Elia Beniash of The Forsyth Institute (Boston, Mass., USA).

All other cell lines were obtained from American Type Culture Collection (Manassas, Va., USA) unless otherwise noted.

All chemicals were purchased from Sigma unless otherwise indicated.

PDMS was purchased from Sylgard, Dow Corning.

Collagen Type-1 Rat Tail (BD Biosciences) 500 μg/ml, FN 5 μg/ml, and HA from rooster comb 5 mg/ml were prepared by diluting in distilled water.

### Cell Culture

All cells were manipulated under sterile tissue culture hoods and maintained in a 95% air/5% CO₂ humidified incubator at 37° C.

NIH-3T3 fibroblasts were maintained in 10% fetal bovine serum (FBS) in Dulbecco's modified eagle medium (DMEM).

AML12 murine hepatocytes were maintained in a medium composed of 10% FBS and 90% of a 1:1 [v/v] mixture of DMEM and Ham's F-12 medium with 5 μg/ml transferrin, 5 ng/ml selenium, and 40 ng/ml dexamethasone.

Confluent flasks of NIH-3T3 and AML12 were fed every 3 to 4 days and passaged when 90% confluent.

Mouse embryonic stem cells (mES) (R1 strain) were maintained on gelatin treated dishes on a medium composed of 15% ES qualified FBS in DMEM knockout medium. The mES cells were fed daily and passaged every 3 days at a subculture ratio of 1:4.

ES cells were maintained on gelatin treated dishes in knockout Dulbecco's modified eagle medium (DMEM) supplemented with 15% (v/v) ES qualified fetal bovine serum (FBS), 1% (v/v) non-essential amino acid solution MEM NEAA, 1 mM L-glutamine, 0.1 mM 2-Mercaptoethanol, and 103 U/ml mouse leukemia inhibitory factor (LIF), ESGRO® (Chemikon Int. Inc., Eugene, Oreg., USA). ES cells were kept undifferentiated by daily media changes and by passaging every 2 days at a subculture ratio of 1:4.

ALCs were maintained in a medium comprised of Spinner modified DMEM containing L-glutamine, supplemented with 10 ng/ml rhEGF, 0.2 mM calcium, 1% (v/v) penicillin-streptomycin, and 10% (v/v) heat-inactivated FBS. The cells were passaged when 90% confluency was reached.

Normal human umbilical vein endothelial cells (HUVECs) were maintained in endothelial cell basal medium from Clonetics EGM-2 Simple Quads (Lonza, Walkersville, Md.). The cells were passaged when 90% confluency was reached.

HL-1 murine cardiomyocytes were maintained in Claycomb media (SAFC Biosciences, Lenexa, Kans., USA) with 1% norepinephrine, 1% (v/v) L-glutamine, 1% (v/v) penicillin-streptomycin and 10% (v/v) FBS. The cells were passaged when 90% confluency was reached.

### Substrate Preparation

Substrates were prepared as follows:

PDMS: Thin PDMS layers were fabricated by pouring a mixture of 10:1 silicon elastomer and curing agent (Sylgard 184, Essex Chemical) in a petri dish. The mixture was then degassed under vacuum until all air bubbles were removed. The mixture was then cured at 70° C. for 2 hours. The PDMS was then cooled to room temperature, cut, and washed with ethanol prior to use.

Glass: Glass slides were used as provided by the manufacturer (Fisher Scientific).

Methacrylate glass: Glass slides were plasma cleaned for 5 minutes, incubated in 3-(Trimethoxysilyl)propyl methacrylate (20% by volume in acetone), air dried for 30 minutes, rinsed with distilled water, and air dried.

Polystyrene substrates: Petri dishes or cell culture plates were used as provided by the manufacturer (Corning).

Silicon: Commercially available silicon wafers were used as purchased.

### EXAMPLES

### Example 1

### Parylene Membrane Fabrication

Three-inch silicon wafer substrates were cleaned by soaking in piranha solution (1H₂SO₄:1 H₂O₂) for 10 minutes, rinsing in deionized water, and nitrogen dried. The clean silicon substrates were coated with hexamethyldisilazane (HMDS) to facilitate later parylene removal.

Parylene-C was deposited onto the coated substrates using a PDS 2010 Labcoater 2 Deposition System (Specialty Coating Systems, Indianapolis, Ind.). A three step deposition process was used, including parylene vaporization, pyrolysis, and deposition. The conditions for vaporization were 150° C. and 1 Torr, during which the parylene-C dimer sublimed into a gaseous dimer form. The dimer was next fed into a furnace (690° C. and 0.5 Torr) to generate the monomer (para-xylylene). The monomer in the deposition chamber (kept at 25° C. and 0.1 Torr) condensed on exposed surfaces and polymerized to form poly-para-xylylene. The monomer was then condensed on exposed surfaces to form a poly-para-xylylene layer having a thickness of about 10 μm.

A 0.2 μm thick aluminum film was subsequently deposited on the parylene film as a hard mask, using vapor deposition. Then, a thin photoresist layer (Shipley, S1813) was spun over the aluminum layer, dried, and exposed to define the desired pattern on the aluminum layer (using a Quintel aligner). The aluminum mask was next etched in an aluminum etchant (PAN Etchant) at 50° C. for 1 min.

The exposed parylene film was then etched using dry etching in an Inductively Coupled Plasma Reactive Ion Etching System (Plasmaterm 790) using O₂. Following this step, the aluminum mask was removed using PAN etchant at 50° C. for 2 minutes.

Individual parylene stencils in the shape of squares were then peeled off from the silicon wafer substrate using fine-edge tweezers or a scalpel, as illustrated in FIG. 1A.

### Example 2

### Parylene Adhesion

Parylene stencils were used as reversibly sealing masks on various substrates, including PDMS, polystyrene, glass, and methacrylated glass. To reversibly seal parylene on these substrates, the hydrophobic, non-etched face of the parylene stencil (i.e., the side of the stencil that was not exposed to the ICP O₂ etchant or PAN etchant) was placed down on the substrate. The parylene stencils were brought in conformal contact with the substrate and, if necessary, pressed together to create a seal with the substrate.

To analyze the potential of parylene stencils for use as a widely applicable membrane for surface pattering, the surface patterning capability of the parylene stencils were tested on a variety of commonly used laboratory substrates including PDMS, polystyrene, and glass. Upon visual inspection, parylene stencils adhered to PDMS substrates strongly and uniformly. A polystyrene substrate was less robust in sealing parylene stencils and may be improved by manual manipulation (pressure) to increase adhesion. In general, parylene stencils did not adhere well to untreated glass substrates. From these observations, it appears that parylene adhesion may be regulated by hydrophobic interactions. For example, parylene, which has a water contact angle of 96°, adheres most strongly to the most hydrophobic substrates, such as PDMS, but does not adhere to a hydrophilic substrate, such as glass.

Contact angle measurements were performed on various surfaces to quantify their hydrophobicity. A Rame-Hart goniometer (Mountain Lakes) equipped with a video camera was used to measure the static contact angles on 3 μL water drops. Reported values represent averages of at least three independent measurements. Parylene-C (96°) which is hydrophobic adheres to PDMS (97°) and polystyrene (˜90°) but not to untreated glass (14°). To increase the applicability of the parylene stencils, we examined the utility of changing the surface hydrophobicity of glass by a methacrylation process. Contact angle measurements showed that treatment of the glass surface with covalently bonded methacrylate groups increased the surface hydrophobicity from 14° for regular glass to 69° for methacrylated glass. Parylene stencils were able to reversibly seal to these treated glass surfaces, enabling the protein patterning (as shown in FIG. 5B).

In addition, it was found that the side of the parylene stencil that is attached to the wafer after fabrication adhered much better to substrates. This may be due to nano-scale irregularities introduced on the top surface of the parylene during the fabrication process, which both roughens the surface of the stencil and renders it hydrophilic.

### Example 3

### Surface Treatment-Adsorption of HA on parylene-C surfaces

The surface properties of parylene-C stencils were engineered by using plasma treatment and layer-by-layer deposition of materials.

Absorption of HA was examined and compared using a number of substrates, including parylene-C, glass, PDMS, and polystyrene. Compared substrates included plasma-treated parylene-C, polystyrene, and PDMS substrates.

The plasma-treated substrates were prepared by plasma treating for 5 minutes using a plasma chamber (Harrick Inc.). The treatment began by starting the vacuum pump to create a vacuum inside the chamber. Then the plasma cleaner was switched on and the glow maintained at a bluish color for cleaning and sterilization, forming plasma treated substrates (designated by the prefix PT-).

Fluorescein-conjugated hyaluronic acid (100 μg/ml) was incubated for 1 hour on the various substrates. The surfaces were then rinsed with distilled water and visualized using the Nikon TE 2000U. Fluorescent intensity distribution was quantified using the NIH-Image J software.

As shown in FIG. 12, HA adsorbed to parylene-C at comparable levels to other commonly used substrates such as PDMS, glass, and polystyrene. In addition, consistent with previously published reports, FIG. 12 shows that plasma treatment causes the substrates to become more hydrophilic and increases HA adsorption compared to untreated substrates. In the case of parylene-C, plasma treatment of parylene-C nearly doubled the adsorption of HA (p<0.01).

The change in surface properties is also show by a change in contact angles of the substrate with water. Specifically, contact angles of PDMS and parylene decrease from ˜110° and ˜75° to <20° following a plasma surface treatment.

### Example 4

### Cell Adhesion on Parylene-C Stencils

NIH-3T3 cells in the appropriate media in the density of ˜780 cells/mm² were incubated on substrates, including parylene-C and parylene-C coated with various coating and combinations of coatings. After 6 hours, the surfaces were washed with PBS and the attached cells were incubated in a solution containing NIH-3T3 media and 1 μg/mL of DAPI for 45 minutes. Several random images were taken using a Nikon TE 2000U camera and spot advanced software. The cells in the image were counted using the NIH-Image J software.

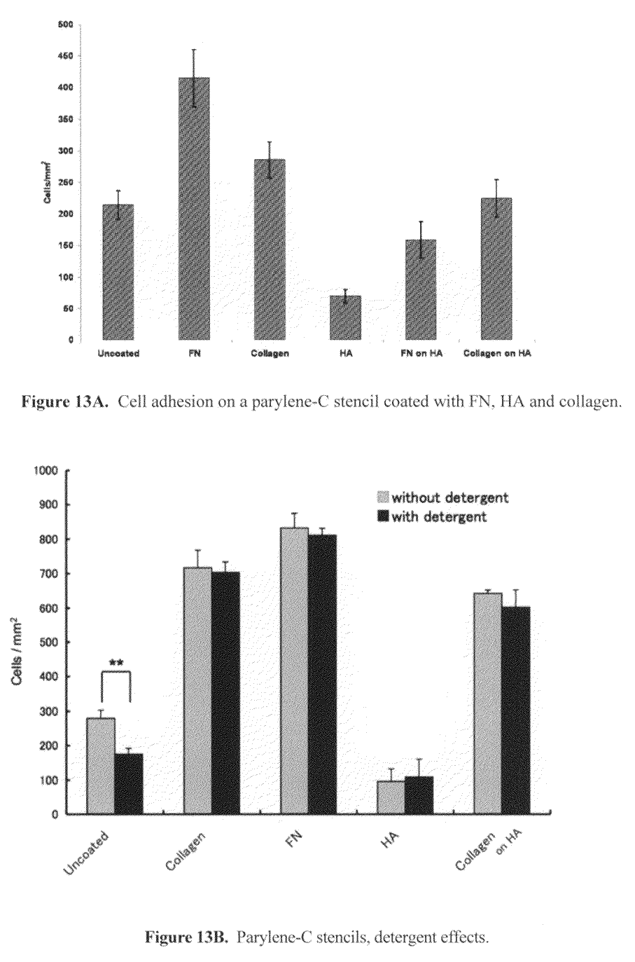

As seen in FIG. 13A, parylene-C surfaces that were coated with FN and collagen had improved cell adhesion properties compared to untreated parylene-C surfaces. Parylene-C surfaces that were coated with HA, or with FN over HA, demonstrated inhibited cell adhesion compared to untreated parylene-C surfaces. Fibronectin application was carried out by diluted FN to a concentration of 2 μg/ml in PBS and incubating the mixture for 30 minutes either on top of the substrate prior to parylene adhesion or on top of the parylene after adhesion. However, collagen adsorbed on HA treated surfaces exhibit a change from cell-repellent to cell-adhesive (compared to an untreated parylene-C surface). As shown, collagen treatment on HA resulted in an increased cell adhesion in comparison to FN treatment on HA.

As shown in FIG. 13B, the effects of detergent on cell adhesion was also examined. The detergent used was detergent micro 90 (International Products Corporation, Burlington, N.J., USA), and the detergent was applied via spin coating to the parylene layer. The FIG. 13B graph compares cell adhesion of NIH-3T3 cells on detergent-treated and untreated parylene-C stencils. NIH-3T3 cells were seeded on surfaces of parylene-C stencils which had been treated with the same ECM components used for generation of multiple co-cultures (namely HA, collagen, and layer-by-layer deposition of collagen on HA). In summary, surface treatment of parylene-C stencils with these ECM components generally increased cell adhesion (as measured after four hours). The results also show that detergent-treated parylene-C membranes compared to untreated ones had an adverse effect on cell adhesion if no additional surface treatment was performed, as the results were significantly different between detergent and un-treated surfaces (p<0.01). Even though cell adhesion on uncoated, detergent-treated parylene-C membranes was low—after surface treatment with any of the applied ECM components listed, cell adhesion on detergent-treated parylene-C membranes was restored to the extent observed with untreated membranes.

In addition, the effects of different substrates and treatments were examined. A shape factor was measured for NIH-3T3 cells deposited on various substrates. NIH-3T3 cells were cultured on various substrates and the cell shape was measured. The shape factor was measured by measuring the area and the perimeter of the attached cells using SPOT advanced software (Diagnostic Instruments Inc.). The formula used for the shape factor was 4*3.14*A/P². A smaller shape factor number essentially means that the cell spreads out on the surface more than a higher shape factor.

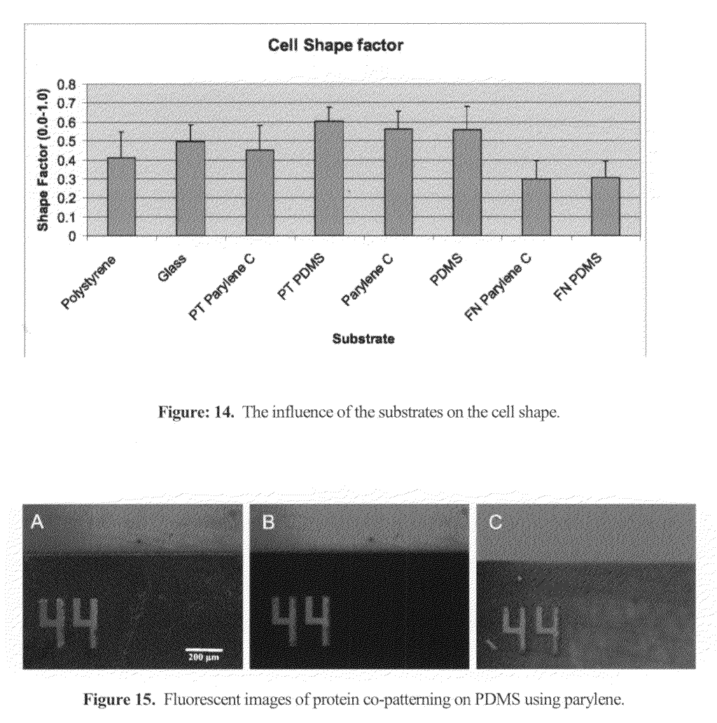

The substrates examined included polystyrene, glass, PDMS, parylene-C, and FN coated PDMS and parylene-C, as well as plasma treated PDMS and parylene-C. The results are shown in FIG. 14. The plasma treated Parylene-C allowed cells to spread out better than glass; while Fibronectin treated parylene had a lower shape factor than polystyrene.

### Example 5

### Cell Staining

To visualize various cell types in patterned co-cultures, cells were stained with fluorescently labeled dyes and tracked in culture. The colors were obtained using the following dyes:

Green carboxyfluorescein diacetate succinimidyl ester (“CFSE”).
Cells were stained with CFSE dye by suspending cells in 10 μg/mL CFSE in PBS solution at a concentration of 1×10⁷ cells/mL and incubated for 10 minutes at room temperature. The staining reaction was quenched by addition of an equal volume of DMEM supplemented with 10% FBS, centrifuged, and resuspended in fresh medium.

Red PKH26.
Cells were stained with PKH26 dye by suspending cells (2×10⁷ cells/mL) in a diluent-C solution and mixed with 4×10⁻⁶ M PKH26 dye in a 1 mL of diluent-C solution and incubated at 25° C. for 5 minutes. The staining reaction was quenched by addition of an equal volume of DMEM supplemented with 10% FBS, centrifuged, and resuspended in fresh medium.

Blue Cell Tracker Blue (Molecular Probes).
Cells were stained with Cell Tracker Blue by centrifuging cells and then resuspending the cells in a pre-warmed working solution having 5 μm dye in PBS and incubated for 15 to 30 minutes under growth conditions appropriate for the particular cell type.

Blue DAPI (4′-6-Diamidino-2-phenylindole)
To stain with DAPI, adherent cells were incubated in 1 μg/ml DAPI in cell culture medium and incubated for 1 hour at 37° C. DAPI staining was used only for the cell adhesion experiments shown in FIG. 13.

### Example 6

### Protein Preparation and Patterning

Fluorescein isothiocyanate-labeled bovine serum albumin (“FITC-BSA”) and Texas Red-labeled BSA (“TR-BSA”) were dissolved in 10 mM PBS solution (pH 7.4; 10 mM NaPO4 buffer, 2.7 mM KCl, and 137 mM NaCl) at concentrations of 50 ng/ml and 20 ng/ml respectively.

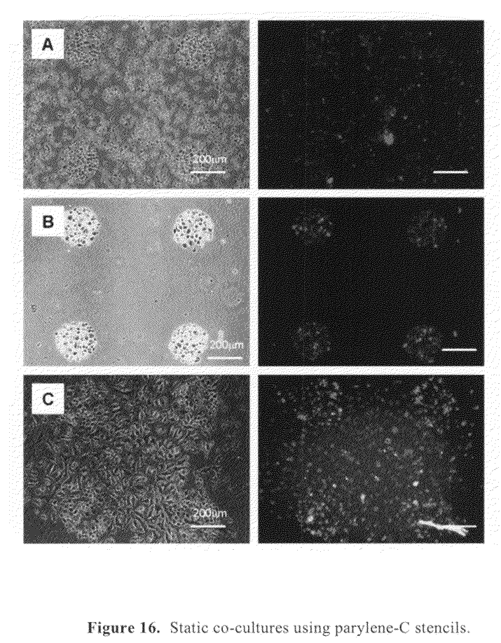

An example of a protein co-pattern is shown in FIG. 15.

A pre-fabricated parylene stencil was removed from a silicon wafer and adhered to a PDMS substrate. Approx. 200 μL of the TR-BSA protein solution was evenly distributed on the stencil and incubated at room temperature for 30 minutes. The substrate with adhered stencil was rinsed with PBS and air dried. The protein pattern was viewed under a fluorescent microscope (TE2000-U, Nikon). The resulting protein pattern and stencil is shown in FIG. 15A.

Then, the parylene stencil was removed by peeling with tweezers to reveal the patterned substrate. The resulting substrate and pattern is shown in FIG. 15B.

Then, a co-pattern protein was incubated on the substrate. Approx. 200 μL of the FITC-BSA protein solution was added to the substrate, followed by evenly distributing the solution on top of the patterned substrate. The substrate was then incubated at room temperature for 30 minutes and analyzed. Images were taken at two different emission wavelengths and merged using SPOT Advanced (Diagnostic Instruments Inc.). The combined image is shown in FIG. 15C. As shown, the protein co-pattern contained distinct regions of green and red fluorescence defined by the parylene stencil pattern. In addition, the border between the two colors was precise, showing no signs of bleeding or mixing. Even though this example was a co-pattern of the same protein with different fluorescent labels, a similar approach would be used with various other combinations of proteins.

### Example 7

### Generation of Static Patterned Co-Cultures

The steps of creating a static patterned co-culture are illustrated in FIG. 16. First, a PDMS substrate was sterilized using ethanol, and then incubated with FN (5 μg/ml) for 45 minutes. Microfabricated parylene-C stencils were then placed on the PDMS substrate and incubated with a suspension of red-stained (see Example 5) mES cells (˜5000 cells/mm2) for 6 hours. The surfaces were then rinsed with PBS to remove non-adherent cells. The results of this can be seen in FIG. 16A, which shows both phase contrast and fluorescent microscope views (Nikon TE 2000U).

The parylene-C stencils were then gently peeled from the PDMS surface to create mES cell micropatterns. This revealed micropatterns of the primary cell type as displayed in FIG. 16B (phase contrast and fluorescent views).

To form patterned static co-cultures, FN (5 μg/ml) was dispensed on the surface of the micropatterned surfaces and incubated for 20 minutes. Green stained AML12 hepatocytes were then seeded (˜5000 cells/mm2) on the resulting surface and incubated for 6 hours. AML12 cells adhered to FN coated surfaces to generate co-cultures of mES cells surrounded by AML12 cells. This is shown in FIG. 16C (normal and fluorescent views).

### Example 8

### Parylene Stencil Recovery

Adsorbed proteins or cells may need to be removed from the stencil prior to reusing the parylene stencils.

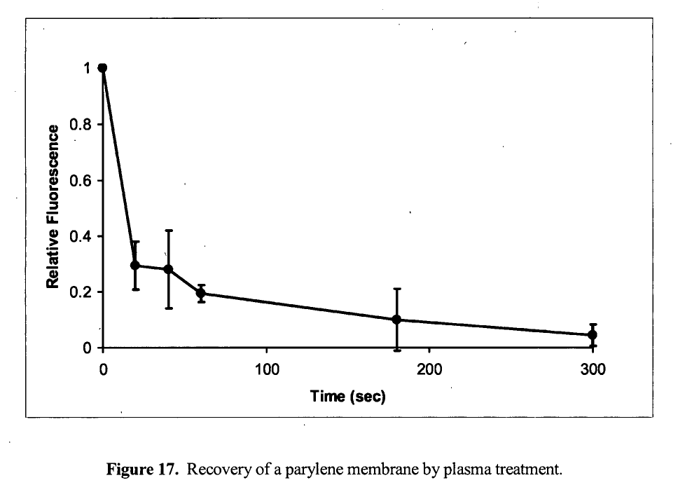

Plasma cleaning was used to remove adsorbed proteins from parylene stencils. To determine the optimum cleaning time, parylene stencils were treated with 20 ng/ml TR-BSA for 15 minutes, and then plasma cleaned at high power (model PDC-001, Harrick Plasma) for varying lengths of time. The relative change in fluorescence was measured and regarded as a measurement correlated to a degradation and loss of protein from the surface of the stencil. FIG. 17 illustrates the recovery of a parylene stencil using plasma treatment. The contamination on the stencil was measured using a measure of relative fluorescence, with the initial fluorescence set to 100%. The only face of the parylene exposed to plasma treatment was the side that had previously been exposed to the protein solution. Fluorescence intensity was measured before and after specific time periods of plasma treatment (Scion Image Software, Scion Corporation). For each length of time, the values from three different trials were averaged.

The results indicate that the relative amount of protein left on the stencil decreases with increased treatment duration. As shown, plasma treatment for 300 seconds reduces the absorbed protein content to nearly 0%, about the original value of an unused stencil.

For cleaning parylene stencils after use in cell patterning, a combination of trypsinizing and plasma cleaning successfully restored the stencil. Parylene stencils were first incubated in Trypsin-EDTA (10×) for 4 minutes to remove cells and then plasma cleaned (as above) to remove any secreted proteins. Cleaned parylene stencils were then reused for cell patterning, showing no observable variation from new stencils. These results demonstrate the potential for reusing these reversible parylene membranes in multiple patterning experiments and applications.

### Example 9

### Dynamic Co-culture

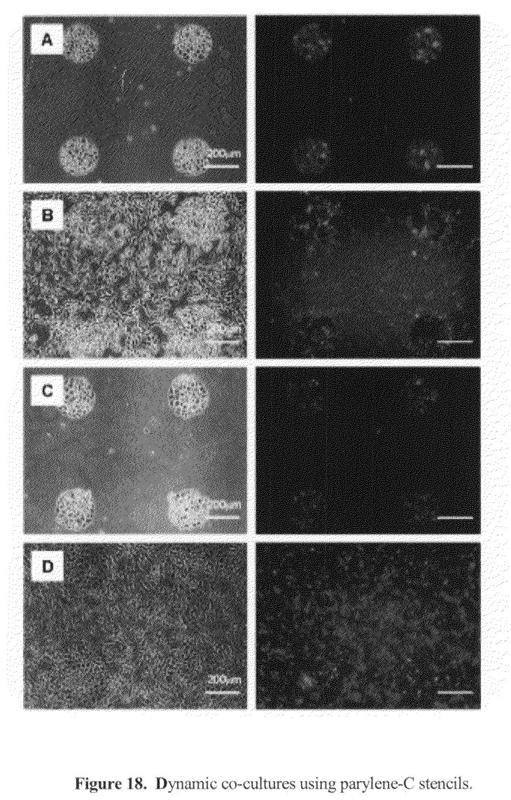

An example of formation of a dynamic co-culture using a parylene stencil is illustrated in FIG. 18. To improve visibility, mES cells were stained with PHK-26 (red), AML12 cells with CSFE (green) and NIH-3T3 cells with Cell Tracker Blue, as described in Example 5.

A parylene-C stencil, having an upper surface that was incubated with HA for 1 hour, was washed and then reversibly sealed on an FN treated PDMS substrate (FN at a concentration of 5 μg/ml coated for 45 minutes) forming a complex. The complex was then placed in a well for cell incubation. mES cells were subsequently seeded on the stencil/PDMS construct and the cells selectively adhered to the FN coated PDMS substrate through the holes of the micropatterned parylene-C stencil as primary cells. The parylene-C stencil was non-adhesive to cells due to the HA coating. Non-adhered cells were then removed by rinsing the surface with PBS. Assisted by the cell adhesion inhibitor (HA) on the stencil surface, few if any cells adhere to the stencil, while the holes are uniformly filled with mES cells, as shown in FIGS. 18A and 18a.

Collagen (500 μg/mL) was incubated for a period of 20 minutes over the HA coating of the parylene-C stencil, changing the surface properties from cell-repulsive to cell-adhesive. AML12 hepatocyte cells (˜5000 cells/mm²) were then seeded into the well as the second type of cells. Incubation of the cells continued for the time needed for the second type of cells to adhere to the surface, which was in the range of 3 to 5 hours. These cells adhered on the parylene membrane coated with collagen, which were devoid of the mES cells, resulting in the formation of a co-culture of mES cells with AML12 cells, as shown in FIGS. 18B and 18b.

Then, to generate a dynamic co-culture, the surface was again washed with PBS to wash away the free cells. The stencil membrane was then gently peeled away using tweezers, leaving only the pattern of mES cells on the PDMS substrate surface, as shown in FIGS. 18C and 18c. The resulting structure was subsequently treated with FN (5 μg/ml for 20 minutes).

NIH-3T3 fibroblast cells (˜5000 cells/mm²) were then seeded into the well as the third type of cells, and incubated over the pattern of the mES cells. The fibronectin adsorbed on the PDMS surface, revealed by removal of the parylene membrane, promoted the adhesion of the third type cells in areas without the mES cells. This formed a co-culture with mES cells, as shown in FIGS. 18D and 18d.

This example demonstrated that the described method enabled mES cells to interact with two different cells sequentially. The ability to generate dynamic co-cultures is important for the study of the stem cell differentiation and fate decisions. Thus a dynamic co-culture of cells of a first type with cells of either a second type or a third type may be useful where the temporal sequence, spatial location, and the type of cells seeded can be altered to study the effects of the sequential variations in cellular interaction with stem cells.

### Example 10

### Growth and Stability of the Patterned Cells and Co-Cultures

The stability of the cell micropatterns generated using parylene-C stencils were examined by tracking micropatterned mES cells either alone or in co-culture for 5 days.

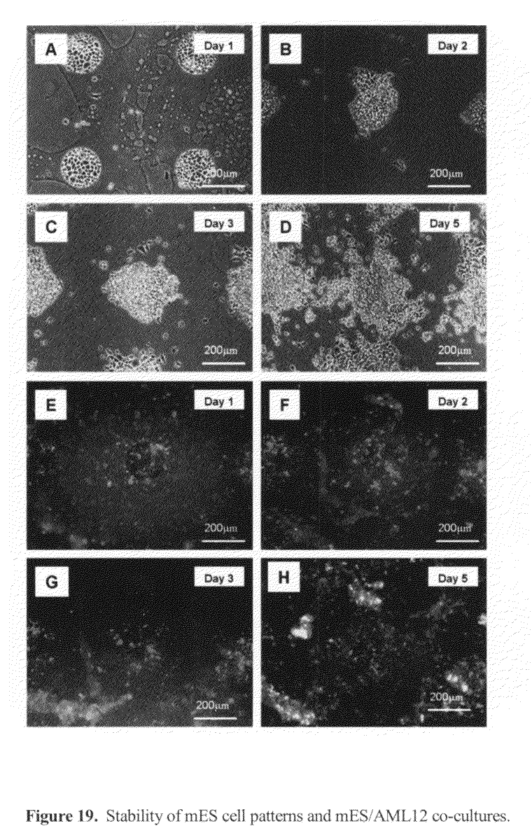

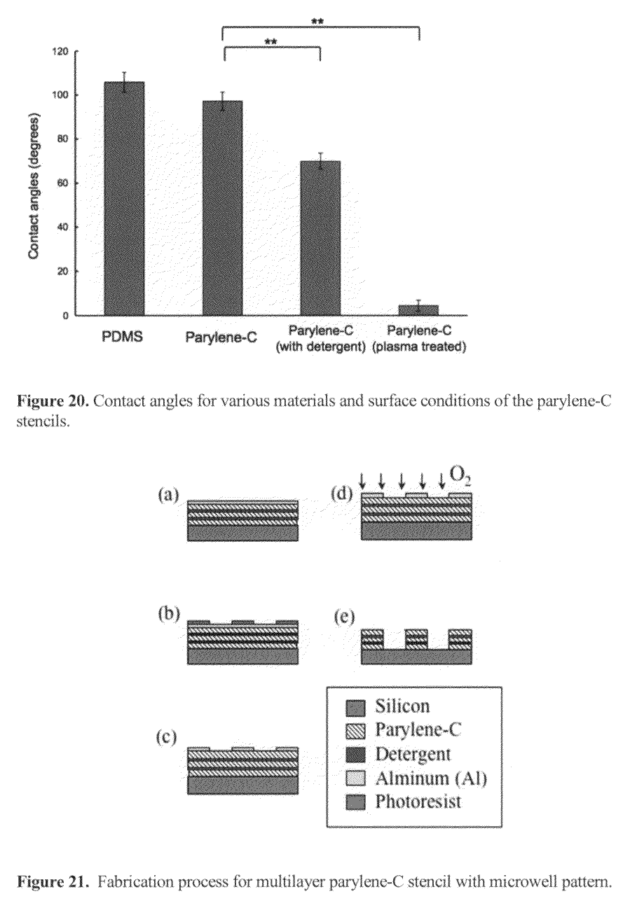

Initially, the stability of mES cell micropatterns surrounded by HA coated surfaces was analyzed. In these studies the stencil was maintained on the surface and the media was replaced every day. As can be seen in FIG. 19, micropatterned mES cells on HA-coated parylene-C stencils maintained their morphology for at least 3 days. However, the patterns degenerated by day 5. These results are shown in FIGS. 19A to 19D, using normal microscopic visualization. These results are in agreement with results obtained using HA coated surfaces generated on other polymer systems.

The stability of the co-cultures of the mES cells with AML12 cells was also studied. Although the pattern integrity was well maintained for 1 day after the initiation of the cultures, mES cells began migrating to the surrounding parylene regions and removing the AML12 cells. It was found that mES cells had displaced many of the surrounding AML12 cells over a period of 5 days. These results are shown in FIGS. 19E-19F, using fluorescent imaging, with mES cells stained red, and AML12 cells stained green.

In general, the stability of micropatterns is a function of a number of parameters including the rate of proliferation, and the mechanical strength of homotypic and heterotypic cell-cell and cell-substrate interactions. Thus, the stability of cultures will likely depend on the types of cells seeded, and their adhesion to each other and to the substrate. Thus, the duration for which patterned co-cultures can be maintained is a function of the specific culture properties.

In summary, microfabricated parylene-C stencils are a potentially powerful method of fabricating patterned co-cultures. The mechanical stability and robustness, as well as the cell compatibility of these membranes make them suitable for cell culture and may be advantageous relative to other stencils. In addition, the ability to fabricate and stack thin parylene-C stencils on each other can be used to generate dynamic co-cultures to control the dynamic interaction of more than 3 cell types by stacking multiple layers of stencils on each other, the removal of each can be used to control cell-cell interaction in a dynamic manner.

### Example 11

### Contact Angle Measurements of Parylene-C Stencils

Contact angles were measured for static drops of water on four different substrates—poly(dimethylsiloxane) (PDMS), parylene-C, parylene-C coated with detergent, and plasma-treated parylene-C—using a contact angle measurement system (Phoenix 300 plus, SEQ Surface Electro Optics Co. Ltd., Korea). Measurements were obtained after dispensing de-ionized water drops onto each substrate using a micropipet (Ted Pella, Inc., Redding, Calif., USA). Each data point represents an average of at least 10 independent measurements.

The surfaces of the untreated parylene-C stencils were hydrophobic, similar to the PDMS substrate. However, when parylene-C membranes were treated with either detergent or reactive oxygen plasma, their surfaces became more hydrophilic. The contact angle measured for parylene-C was significantly different from angles measured for detergent- and plasma-treated parylene-C (** indicates p<0.01).

### Example 12

### Preparation of Multi-Layer Parylene-C Stencils

3-inch silicon wafers were cleaned with piranha solution (1H₂SO₄: 1H₂O₂) for minutes, rinsed in deionized water, nitrogen dried, and baked for 10 minutes at 150° C. The wafers were then coated with hexamethyldisilazane (HMDS) to facilitate the removal of the finished parylene-C stencil.

This example of a fabrication process of multilayer parylene-C stencils with microwell pattern is illustrated in FIG. 21.

A thin (5 μm or 10 μm) film of parylene-C was first deposited on a silicon wafer using a PDS 2010 Labcoater 2 Parylene-C Deposition System (Specialty Coating Systems, Indianapolis, Ind., USA). An anti-stiction layer (detergent, micro 90, International Products Corporation, Burlington, N.J., USA) was applied via spin coating to the parylene layer. Second and third layers of parylene-C were then deposited using the same procedure with a corresponding anti-stiction layer after the second layer of parylene-C. Following the third parylene-C layer, a 200 nm thick Aluminum layer was deposited and patterned as a hard mask.

Microwells were created on the parylene stencil utilizing low temperature (5° C.) dry etching in an Inductively Coupled Plasma reactor (Plasmatherm 790). After etching, the Aluminum hard mask was removed utilizing PAN etchant at 50° C. for 2 minutes.

Using this same technique, three multilayer stencils were fabricated (with stencil layer thicknesses of 5-5-5 μm, 5-5-10 μm, and 10-10-10 μm [from top to bottom]) of peelable multilayer parylene-C stencils. In all stencils, the microwell diameter was 200 μm.

### Example 13

### SEM Analysis of Multi-Layer Parylene-C Stencils

The produced, peelable, multilayer parylene-C stencils produced according to Example 12 were analyzed via SEM using a Zeiss Supra 25 (Carl Zeiss Microscopy, Jena, Germany). After fabrication, the parylene-C stencils were cut in half. Cross-sectional views were then obtained using SEM to characterize the profiles and thicknesses of the stencil layers.

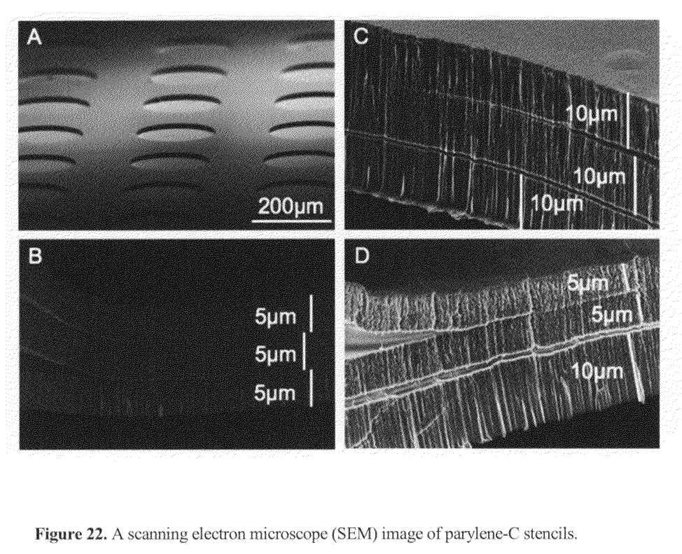

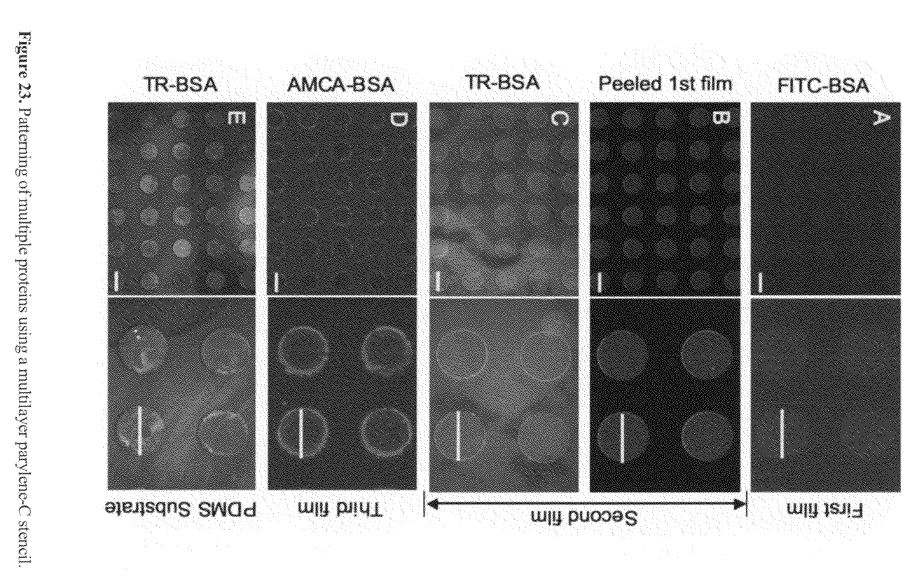

FIG. 22 shows scanning electron microscope (SEM) images of parylene-C stencils. An oblique view on the top of the stencil displays a pattern of microwells with 200 μm diameter with almost vertical side walls (FIG. 22A). The three-layered parylene-C stencils were engineered with three combinations of layer thicknesses. Cross sectional images of the stencils were taken at higher magnification to depict the individual layers. The images show three-layered parylene-C stencils with individual film thicknesses of (from top to bottom) 5-5-5 μm (FIG. 22B), 10-10-10 μm (FIG. 22C) and 5-5-10 μm (FIG. 22D).

### Example 14

### Patterning of Multiple Proteins

Multilayer parylene-C stencils, prepared according to the process of Example 12, were reversibly sealed on a PDMS surface and the individual layers were subsequently patterned with BSA coupled to different fluorophores.

FIG. 23 shows images taken during patterning of multiple proteins using a multilayer parylene-C stencil. First, both the top stencil layer and the PDMS substrate exposed through the stencil microwells were coated for 30 minutes with 100 μg/ml fluorescein isothiocyanate (FITC) coupled to BSA. After checking the protein adsorption, the top stencil was gently peeled off using tweezers to yield a FITC-BSA protein pattern only inside the 200 μm microwells. Second, the next stencil layer was patterned with 50 μg/ml Texas Red-BSA (TR-BSA) for 30 minutes to yield a co-pattern with the FITC-BSA. The next stencil layer (initially middle stencil layer) was then peeled off. Third, the underlying (bottom) stencil layer was coated for 30 minutes with 50 μg/ml 6-((7-Amino-4-methylcoumarin-3-acetyl)amino)hexanoic acid (AMCA) coupled to BSA, yielding another protein co-pattern. Finally, after removal of the bottom stencil, the PDMS surface was patterned with 50 μg/ml TR-BSA for 30 minutes. All BSA-coupled fluorophores were purchased from Sigma Aldrich Co. (St. Louis, Mo., USA), except AMCA-BSA. To create AMCA-BSA, BSA was conjugated with the blue fluorophore AMCA using the AnaTag AMCA-X microscale protein labeling kit, ANASpec (San Jose, Calif., USA).

The images of FIG. 23 of parylene-C stencils co-patterned with fluorescent BSA were taken at 4× and 10× magnifications using an inverted fluorescent microscope (Nikon Eclipse TE2000-U). These images indicate that FITC-BSA protein could adsorb to the PDMS substrate inside the microwells and was retained even after multiple co-patterns (Scale bars=200 μm).

### Example 15

### Generation of Dynamic Co-Cultures Using Multilayer Stencil

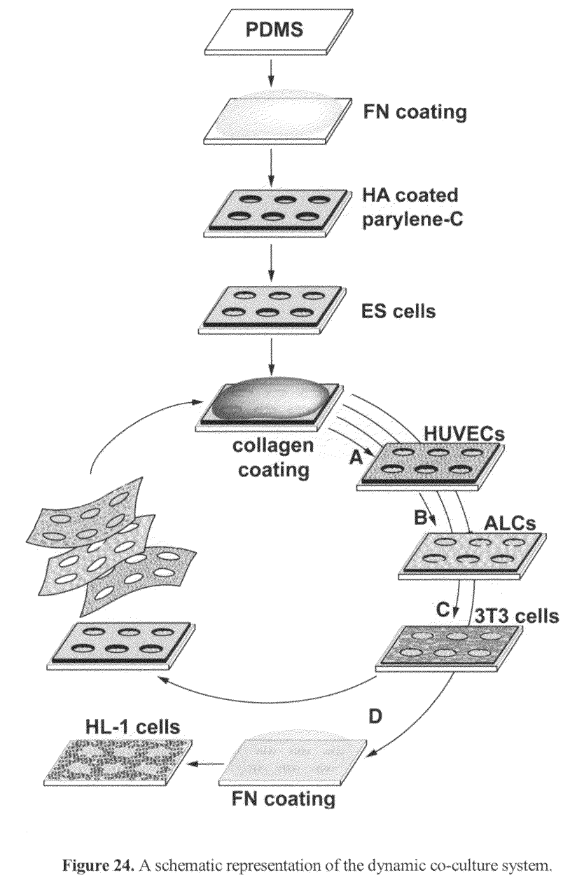

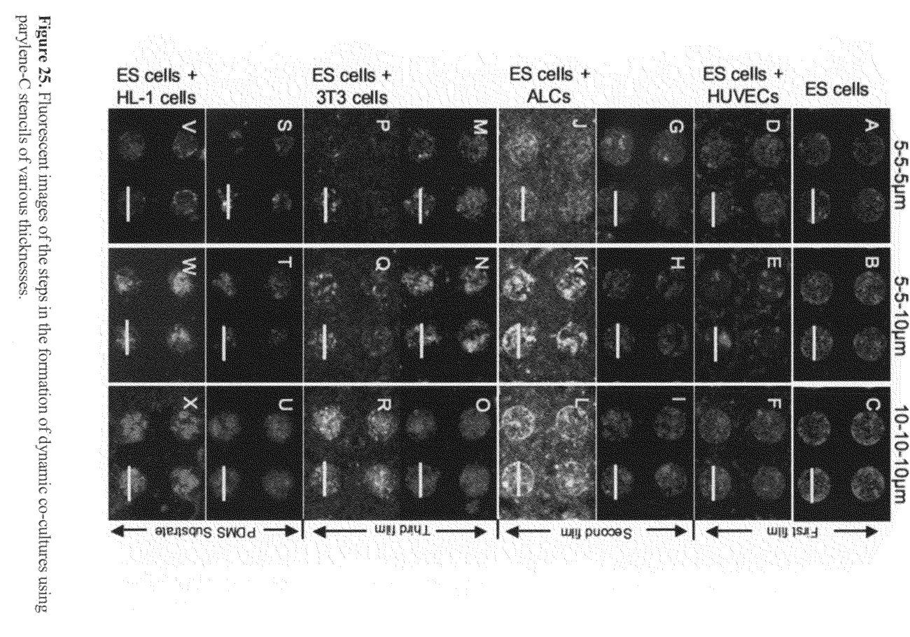

Dynamic co-cultures were generated as outlined in FIG. 24, which presents a schematic representation of the dynamic co-culture system described below.

The PDMS substrates were fabricated by curing a silicone elastomer solution mixed in a 10:1 ratio with curing agent Sylgard 184, (Dow Corning Corporation, Midland, Mich., USA) inside a Petri dish for 2 hours. The PDMS substrates were then coated with a 20 μg/ml FN solution for 1 hour. Multilayer parylene-C stencils, prepared according to Example 12, were first incubated with HA (5 μg/ml) for 1 hour. After incubation, stencils were washed and reversibly sealed on FN-treated PDMS substrates inside Petri dishes.

ES cells (˜5000 cells/mm2) were then seeded onto the parylene-C stencils and incubated for 6 h at 37° C. Cells selectively adhered to the FN-coated PDMS surface through the 200 μm holes in the stencil (as the top parylene-C layer was cell-repellant due to HA coating). The top surface of the stencil was next coated for 10 minutes with a 500 μg/ml collagen solution prior to the seeding of the second cell type.

HUVECs (˜5000 cells/mm2) were then seeded onto the stencil surface and incubated for 4 hours. After incubation, the HUVECs were removed by peeling off the top layer of the stencil. Another collagen coating was applied for 10 minutes.

Next, ALCs were seeded (˜5000 cells/mm2) and again incubated with the ES cells for 4 hours. The ALCs were then removed by peeling away the second parylene-C layer. Before seeding the fourth cell type, the last remaining parylene-C layer was coated with collagen.

NIH-3T3 cells were then seeded at a density of 5000 cells/mm2, and incubated for 4 hours with the ES cells before the bottom layer of the parylene-C stencil was removed from the PDMS surface.

Finally, the PDMS surface was coated with FN at a concentration of 20 μg/ml for 10 minutes, and HL-1 cells were seeded (˜5000 cells/mm2) as the fifth cell type. The ES cells were co-cultured for another 4 hours with the HL-1 cells.

FIG. 25 shows fluorescent images of the cell-cultures in the formation of dynamic co-cultures using parylene-C stencils of various thicknesses following the above steps (5-5-5, 5-5-10, and 10-10-10 μm). HA-coated parylene-C stencils were reversibly sealed on FN-treated PDMS and then seeded with murine embryonic stem (ES) cells (green, A-C). The ES cells were first co-cultured with HUVECs (red, D-F) on top of the first parylene-C layer of the stencil. After peeling away the top layer together with the HUVECs (G-I), ALCs (yellow) were seeded onto the second stencil layer (J-L). After peeling off this second layer, NIH-3T3 cells (pink) were co-cultured (P-R). After removal of the NIH-3T3 cells (S-U), HL-1 cells (purple) were patterned on the exposed PDMS substrate (V-X) for the last co-culture (Scale bars=200 μm). Rows of images show the co-culture experiment performed with stencils of all three designs, with thicknesses of individual layers of (from top to bottom) 5-5-5, 5-5-10 and 10-10-10 μm. The ES cell pattern inside 10-10-10 μm stencils remained most stable after this sequence of four co-cultures.

Other co-culture combinations may be produced following a similar procedure, as the duration of the co-cultures and the series of cell types can be varied depending on purpose.

### Example 16

### Analysis of the ES Cell Retention

The number of ES cells that were retained inside wells after peeling off the individual film layers of the multilayer stencil were analyzed. Parylene-C stencils of different film thicknesses (5 μm-5 μm-5 μm, 10 μm-5 μm-5 μm, and 10 μm-10 μm-10 μm), prepared according to Example 12, were compared for their ability to retain ES cells during dynamic co-culturing. For different stencils, the number of ES cells inside randomly selected microwells was counted after each step of the dynamic co-culture process, described above in Example 15. The obtained mean values were evaluated and statistical analysis was performed using a two-tailed multiple t-test with Bonferroni correction, followed by a two sided analysis of variances (ANOVA), with p<0.05 considered statistically significant.

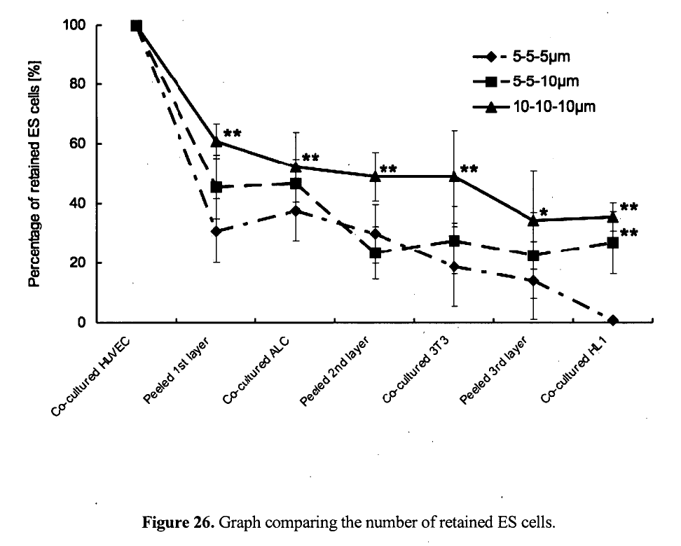

FIG. 26 shows a graph comparing the number of retained ES cells in the wells for multilayer stencils with various layer thickness combinations. In all stencils, some ES cells were removed from the microwell during peeling off the parylene-C layers. In subsequent seeding steps, secondary cell types settled in unoccupied areas inside the microwells, disintegrating the ES cell pattern (FIG. 26 V, W). Retained cell numbers in the parylene-C microwells were significantly different between layer thickness combinations (p<0.01). There was a statistically significant difference between each of the corresponding points on the 5-5-5 μm and 10-10-10 μm curves. 5-5-10 μm stencils—stencils in which only the bottom layer was increased in thickness to provide protection to the ES cell pattern—showed improved pattern stability towards the end of the co-culture sequence, leading to a significant increase of retained ES cells during the final co-culture with HL-1 cells. The 10 μm thick parylene-C layer on the bottom of these stencils retained cells more effectively than the previous 5 μm thick layers, leading us to conclude that thicker stencils improve the stability of the ES cell pattern. These results indicate that stability of micropatterned cells within parylene-C microwells depends in part on the stencil layer thickness combination.

A number of embodiments of the invention have been described. Nevertheless, it will be understood that various modifications may be made without departing from the spirit and scope of the invention. For example, multiple layers of stencils, or multiple stencils, may be used to create even more complex patterns and cell interactions than those created with a single stencil. In addition, other cells, proteins, or biological material may be used in similar manner as described. Accordingly, other embodiments are within the scope of the following claims.

What is claimed is:

1. A process for using a stencil in a microfabrication process, comprising:
applying a biocompatible, prefabricated, microfabrication stencil to a substrate to form a complex;
incubating a biomaterial over the complex;
removing the stencil from a substrate; and
cleaning the stencil to remove biological deposits.

2. The process of claim 1, wherein applying a biomaterial comprises incubating a biomaterial.

3. The process of claim 1, further comprising applying a second biomaterial over the substrate after removal of the stencil.

4. The process of claim 1, wherein the stencil comprises parylene-C.

5. The process of claim 1 wherein the biomaterial comprises a protein or cell type.

6. The process of claim 1, wherein the stencil is cleaned using plasma cleaning.

7. The process of claim 1, wherein the stencil is cleaned using trypsin.

8. A process of forming a complex microenvironment, comprising:
applying a parylene microfabrication stencil to a substrate to form a complex;
incubating a first biomaterial over the complex;
removing the stencil from the complex to produce an altered complex;
incubating a second biomaterial over the altered complex; and
cleaning the stencil.

9. The process of claim 8, further comprising:
changing the characteristics of the stencil after incubation of the first biomaterial; and
incubating a third biomaterial over the complex with the stencil having changed surface properties.

10. The process of claim 8, wherein changing the characteristics of the stencil comprises changing the stencil surface property from cell-repelling to cell-attracting.

11. A process of preparing a reusable microfabrication stencil, comprising:
preparing a wafer substrate;
depositing a parylene material on the wafer;
applying a pattern over the parylene material;
selectively removing parylene material to incorporate the pattern into the parylene material to form a stencil; and
removing the stencil from the wafer.

12. The process of claim 11, further comprising applying a protective layer onto the parylene.

13. The process of claim 12, further comprising applying a photoresist layer over the protective layer.

14. The process of claim 11, wherein the parylene material is removed using ICP-RIE.

15. The process of claim 11, wherein the parylene material layer has a thickness of at least 5 μm.

16. The process of claim 11, wherein the parylene material comprises parylene-C.

17. An article, comprising:
a substrate; and
a parylene microfabrication stencil reversibly bonded to the substrate,
wherein the microfabrication stencil includes one or more features, and wherein the microfabrication stencil may be removed from the substrate and reversibly bonded to a second substrate without significant damage to the stencil or to features of the stencil.

18. The article of claim 17, wherein the microfabrication stencil comprises parylene-C.

19. The process of claim 17, wherein the microfabrication stencil may be used and reused at least five times without causing significant damage to the features of the stencil or to the stencil material.

20. A process of forming a complex biological microenvironment, comprising:
applying a multilayer microfabrication stencil to a substrate to form a first complex;
incubating a first protein or cell type over the first complex;
incubating a second protein or cell type over the first complex;
removing a first layer of the multilayer stencil to form a second complex;
incubating a third protein or cell type over the second complex;
removing a second layer of the multilayer stencil to form a third complex; and
incubating a fourth protein or cell type over the third complex.

21. The process of claim 20, further comprising:
removing a third layer of the multilayer stencil to form a fourth complex; and
incubating a fifth protein or cell type over the fourth complex.

22. The process of claim 20, wherein each layer of the multilayer stencil is formed from a material comprising parylene.
